(19) United States
(12) Patent Application Publication
(10) Pub. No.: US 2015/0068674 A1
(43) Pub. Date: Mar. 12, 2015

(54) METHOD FOR MANUFACTURING DISPLAY DEVICE

(71) Applicant: Sharp Kabushiki Kaisha, Osaka (JP)

(72) Inventors: Kenichiroh Tsuchida, Osaka (JP); Takayuki Yamada, Osaka (JP); Tomoo Takatani, Osaka (JP); Hiroshi Fukushima, Osaka (JP)

(73) Assignee: Sharp Kabushiki Kaisha, Osaka (JP)

(21) Appl. No.: 14/394,684

(22) PCT Filed: Apr. 19, 2013
(86) PCT No.: PCT/JP2013/061582

§ 371 Date: Oct. 15, 2014

(30) Foreign Application Priority Data
Apr. 26, 2012 (JP) 2012-101656

(51) Int. Cl. B32B 37/12; G02B 27/22; G02F 1/1333; B32B 38/00

(52) U.S. Cl. CPC B32B 37/1292; B32B 37/1284; B32B 38/0008; G02B 27/2214; G02F 1/133305; G02F 1/1333; B32B 2037/1253; B32B 2310/0831; B32B 2457/202
USPC 156/275.5; 156/60; 156/295

(57) ABSTRACT

A method of manufacturing the liquid crystal display device (display device) includes: a step of coating a liquid adhesive material on at least one of opposing surfaces of a liquid crystal display panel (display panel) that displays images or a parallax barrier panel (function panel) to be stacked onto the liquid crystal display panel; a step of attaching the liquid crystal display panel to the parallax barrier panel through an adhesive material; and a step of partial curing in which an overlapping portion of the adhesive material overlapping in a plan view an outer edge portion of at least one of the liquid crystal display panel and the parallax barrier panel is cured.

### TECHNICAL FIELD

The present invention relates to a method of manufacturing a display device.

### BACKGROUND ART

Display devices including display panels such as liquid crystal panels are used in electronic devices such as mobile information devices such as mobile phones, smartphones, and PDAs; computers; and television receivers. Among such display devices, those that include a function for displaying three-dimensional images relying on a property of human eyes in which the left and right eyes see from differing perspectives (so-called binocular parallax) allowing a three-dimensional image to be perceived are known, such a function being known as the “parallax barrier mode.” An example of a display device including such a function to display three dimensional images is that disclosed in Patent Document 1 below, and in the disclosed device, a parallax barrier panel having a barrier light-shielding layer is attached to a liquid crystal panel, which displays images. One known example of this type of display device is that disclosed in Patent Document 1 below.

### RELATED ART DOCUMENTS

### Patent Documents

Patent Document 1: Japanese Patent Application Laid-Open Publication No. 2005-181410

### Problems to be Solved by the Invention

In the device disclosed in Patent Document 1, a liquid crystal panel, which displays images, and a parallax barrier panel are attached to each other through a bonding resin layer, and the amount of the bonding resin layer leaking out from the edge face of the panel having a smaller area is restricted to within a certain numerical range. However, due to individual differences in the coating devices used to coat the bonding resin layer and the pressurizing device used for attaching, environmental changes such as changes in temperature and humidity, and the like, it is difficult to strictly control the amount of the bonding resin layer leaking out, and there were cases in which the amount of the bonding resin layer leaking out was excessive. If an excessive amount of the bonding resin layer leaked out, there was a possibility that the this bonding resin layer that has leaked out could stick to the outer surfaces of the liquid crystal panel and the parallax barrier panel, thus reducing display quality.

### SUMMARY OF THE INVENTION

The present invention is completed in view of the above-mentioned situation, and an object thereof is to mitigate leakage of the adhesive material.

### Means for Solving the Problems

A method of manufacturing a display device of the present invention includes: coating a liquid adhesive material on an opposing surface of at least either of a display panel that displays images and a function panel to be stacked on the display panel; attaching the display panel to the function panel through the adhesive material; and curing an overlapping portion of the adhesive material that overlaps an outer edge portion of at least one of the display panel and the function panel in a plan view.

In this manner, in the step of coating the adhesive material, the liquid adhesive material is coated on at least one of opposing faces of the display panel and the function panel, and in the attaching step thereafter, the display panel and the function panel are attached through the adhesive material. The method of manufacturing the display device includes the partial curing step, and by curing the overlapping portion of the adhesive material overlapping in a plan view the outer edge portion of at least one of the display panel and the function panel, the adhesive material is partially cured, and thus, it is possible to stop the non-cured central portion of the adhesive material from leaking out due to the cured overlapping portion. As a result, even if the amount of adhesive material coated during the step of coating the adhesive material varies or if the pressure applied to the display panel and the function panel in the step of attaching these panels to each other varies, the adhesive material is less susceptible to leaking to the outside of either of the outer edges of the display panel and the function panel. Therefore, a situation in which the adhesive material sticks to the outer surfaces of the display panel or the function panel, for example, is prevented, and high display quality can be maintained.

As embodiments of the present invention, the following configurations are preferred.

(1) In the step of partially curing the overlapping portion of the adhesive material, a degree of curing of an outer edge portion of the overlapping portion located towards an outside is relatively high, and the degree of curing of an inner edge portion of the overlapping portion located towards an inside is relatively low. In this manner, when performing the step of partial curing, the degree of curing increases in the order of the non-cured central portion of the adhesive material, the inner edge portion of the overlapping portion, and the outer edge portion of the overlapping portion, which means that the degree of curing changes in a stepwise fashion. Thus, stress that could result from contraction due to curing in the boundary between the non-cured central portion and the overlapping portion can be mitigated, and thus, a situation in which display quality is worsened as a result of residual stress in the adhesive material acting on the display panel, for example, is less likely to occur.

(2) In the step of coating the adhesive material, a photocurable adhesive material is coated as the adhesive material, and in the step of partially curing the overlapping portion of the adhesive material, light to induce curing is radiated on the overlapping portion of the photocurable adhesive material. In this manner, in the partial curing step, light to induce curing in the overlapping portion of the photocurable adhesive material is radiated, and thus, the photocurable adhesive material is partially cured, which means that it is possible to set with high accuracy the range of the photocurable adhesive material to be cured, resulting in partial curing of the photocurable adhesive material being performed with greater reliability. Also, the photocurable adhesive material can be cured faster than thermosetting adhesive materials or the like, for example, and thus, the cycle time can be shortened.

(3) In the step of coating the adhesive material, an ultraviolet curable adhesive material is coated as the photocurable adhesive material, and in the step of partially curing the overlapping portion of the adhesive material, ultraviolet rays to induce curing are radiated on the overlapping portion of the ultraviolet curable adhesive material. In this manner, compared to a case in which a visible light curable adhesive material is used as the photocurable adhesive material, it is possible to set up with relative ease a configuration in which unwanted curing does not occur from when the adhesive material coating step is performed to when the attaching step is performed, and thus, it is possible to reduce costs such as equipment costs. Also, the ultraviolet curable adhesive material can be cured quickly, and thus, cycle time can be further reduced.

(4) In the step of partially curing the overlapping portion of the adhesive material, the ultraviolet rays are radiated on the overlapping portion through the function panel. In this manner, compared to a case in which ultraviolet rays are radiated on the overlapping portion through the display panel, a problem in which structures provided in the display panel undergo a change in properties becomes unlikely to occur. As a result, the image displayed on the display panel can have excellent display quality.

(5) The method of manufacturing a display device further includes: manufacturing at least one of the display panel and the function panel, made by attaching together a pair of light-transmissive substrates, such that one of the pair of substrates has a projection that projects further outward than another of the pair of substrates along an entire periphery thereof is further included, wherein, in the step of partially curing the overlapping portion of the adhesive material, the outer edge portion of the overlapping portion towards the outside is irradiated with the light through the projection of the one of the pair of substrates, whereas the inner edge portion of the overlapping portion located towards the inside is irradiated with light through the pair of substrates. In this manner, when performing the partial curing step, light is radiated on the outer edge portion only through the projection of one of the substrates, and thus, the amount of illumination light on the outer edge portion and the resulting degree of curing become relatively high, whereas light is radiated on the inner edge portion through both of the pair of substrates, and thus, the amount of light radiated on the inner edge portion becomes small due to absorption and reflection of light by the other substrate, thus resulting in the degree of curing therein to be low. As a result, the degree of curing becomes higher in the order of the non-cured central portion of the adhesive material, the inner edge portion of the overlapping portion, and the outer edge portion of the overlapping portion and the degree of curing changes in a stepwise fashion, and thus, stress that could occur due to contraction resulting from curing in the boundary between the non-cured central portion and the overlapping portion is mitigated. Therefore, a situation in which display quality is worsened due to residual stress in the adhesive material acting on the display panel, for example, is mitigated. Furthermore, in the step of partial curing, the amount of illumination light on the overlapping portion is differed for the respective portions, relying on the step formed between the pair of substrates, and thus, costs associated with the device that radiates light can be reduced.

(6) In the step of attaching, the display panel is attached to the function panel such that the another of the pair of substrates faces the adhesive material. In this manner, the distance between the display panel and the function panel is greater in the area where the projection is provided in one of the substrates than in areas where the other substrate is provided. As a result, in the space where the adhesive material is disposed, the area where the outer edge portion of the overlapping portion is present is greater than the area where the inner edge portion of the overlapping portion is present, and thus, leakage of the adhesive material is further mitigated.

(7) The step of partially curing the overlapping portion of the adhesive material is performed simultaneously to the step of attaching. In this manner, compared to a case in which the partial curing step and the attaching step were performed independently of each other, it is possible to shorten the amount of time taken for the entire manufacturing process.

(8) In the step of coating the adhesive material, the adhesive material is coated on a portion of at least one of the respective opposing surfaces of the display panel and the function panel, and in the step of attaching, the adhesive material is spread under pressure by applying pressure to at least one of the display panel and the function panel. In this manner, in the attaching step, pressure is applied to at least one of the display panel and the function panel, thus spreading under pressure the liquid adhesive material, and the spreading adhesive material is cured in the overlapping portion, and thus, the non-cured central portion can be prevented from leaking outside of the overlapping portion. In this manner, compared to a case in which the adhesive material is coated in a planar form on the opposing surface, it is possible to improve the efficiency of coating the adhesive material, thereby being suitable for reasons such as a reduction in cycle time.

(9) In the step of coating the adhesive material, the adhesive material is coated onto a central portion surrounded by the outer edge portion of at least one of the display panel and the function panel, and in the step of partially curing the overlapping portion of the adhesive material, curing is performed on the adhesive material, spreading in the step of attaching, prior to the adhesive material reaching the outer edge portion of the display panel and the function panel. In this manner, it is possible to more reliably cure the overlapping portion of the adhesive material that has reached the outer edge portion of the display panel and the function panel by being spread in the attaching step. As a result, it is possible to more reliably prevent leakage of the non-cured portion of the adhesive material.

(10) In the step of partially curing the overlapping portion of the adhesive material, the overlapping portion is half-cured. In this manner, even if air bubbles form in the non-cured portion of the adhesive material in the attaching step, the overlapping portion is half-cured, and thus, the air bubbles in the non-cured portion can be released outside through the overlapping portion. As a result, the remaining of air bubbles in the adhesive material becomes unlikely, which means that display quality of images displayed in the display panel can be maintained at a high level.

(11) The method of manufacturing a display device further includes: adjusting a position of the display panel relative to the function panel in a direction along surfaces thereof, after the step of attaching and the step of partially curing the overlapping portion of the adhesive material. In this manner, in the partial curing step, the overlapping portion is half-cured, and thus, in the position adjusting step performed thereafter, it is possible to position the display panel and the function panel with respect to each other in the direction along the surfaces thereof. As a result, the positioning accuracy of the display panel and the function panel can be made high.

(12) In the step of attaching, a parallax barrier panel that can split by parallax an image displayed in the display panel is attached to the display panel as the function panel. In this manner, in the position adjusting step, positioning accuracy in the direction along the surfaces of the display panel and the parallax barrier panel can be made high, and thus, it is possible to more suitably exhibit the function of the parallax barrier panel, thereby making it possible for a user of the display device to perceive an excellent three dimensional image.

(13) In the step of attaching, a touch panel that can detect an input position by a user of the display device is attached to the display panel as the function panel. In this manner, in the position adjusting step, the positioning accuracy in the direction along the surfaces of the display panel and the touch panel can be made high, and thus, it is possible to more suitably exhibit the function of the touch panel, thereby making it possible to detect with greater accuracy a position inputted by a user of the display device.

(14) In the step of partially curing the overlapping portion of the adhesive material, curing is performed on the overlapping portion of the adhesive material that overlaps in a plan view a non-display region surrounding a display region where images are displayed in the display panel. In this manner, even if uneven curing occurs in the overlapping portion of the adhesive material during the partial curing step, the overlapping portion is the portion of the display panel overlapping the non-display region in a plan view, and thus, a situation in which display quality of images displayed in the display region is reduced by the overlapping portion is prevented.

### Effects of the Invention

According to the present invention, it is possible to suppress leakage of the adhesive material.

### BRIEF DESCRIPTION OF THE DRAWINGS

FIG. 1 is a schematic cross-sectional view of a liquid crystal display device according to Embodiment 1 of the present invention.

FIG. 2 is a plan view of a liquid crystal display device.

FIG. 3 is a cross-sectional view of a liquid crystal display panel and a parallax barrier panel.

FIG. 4 is a plan view of the liquid crystal display panel connected to a flexible substrate for display.

FIG. 5 is a plan view showing an arrangement of pixel electrodes and respective wiring lines on an array substrate of the liquid crystal display panel.

FIG. 6 is a plan view showing an arrangement of colored portions on a CF substrate of the liquid crystal display panel.

FIG. 7 is a cross-sectional view showing a cross-sectional configuration of a display region of the liquid crystal display panel.

FIG. 8 is a plan view of a parallax barrier panel connected to a flexible substrate for a barrier.

FIG. 9 is a plan view of a first substrate of the parallax barrier panel.

FIG. 10 is a plan view of a second substrate of the parallax barrier panel.

FIG. 11 is a drawing for describing schematically a relation between a barrier portion and a barrier opening of the parallax barrier panel, and right eye pixels and left eye pixels of the liquid crystal display panel.

FIG. 12 is a plan view of a parallax barrier panel after a step of coating by an adhesive has been performed thereon.

FIG. 13 is a cross-sectional view showing a state prior to the liquid crystal display panel being attached to the parallax barrier panel after having been coated by the adhesive.

FIG. 14 is a cross-sectional view showing a state in which the parallax barrier panel, which has been coated by the adhesive, is attached to the liquid crystal display panel and ultraviolet rays are radiated towards areas overlapping the adhesive material, thereby performing the step of attaching and a step of curing portions.

FIG. 15 is a cross-sectional view showing a state in which overlapping portions of the adhesive material that has spread by being pressed by the liquid crystal display panel have been cured by ultraviolet rays.

FIG. 16 is a cross-sectional view of FIG. 15 along the line xvi-xvi.

FIG. 17 is a cross-sectional view showing a state in which a position adjusting step has been performed such that the liquid crystal display panel and the parallax barrier panel are positioned in a direction along the plate surfaces.

FIG. 18 is a cross-sectional view showing a state in which a step of curing all of the adhesive material has been performed.

FIG. 19 is a cross-sectional view of a liquid crystal display panel and a touch panel according to Embodiment 2 of the present invention.

FIG. 20 is a plan view of the touch panel.

FIG. 21 is a cross-sectional view showing a state prior to the liquid crystal display panel being attached to the touch panel after having been coated by the adhesive.

FIG. 22 is a cross-sectional view showing a state in which overlapping portions of the adhesive material that has spread by being pressed by the touch panel have been cured by ultraviolet rays.

FIG. 23 is a cross-sectional view showing a state in which a step of curing all of the adhesive material has been performed.

FIG. 24 is a cross-sectional view of a liquid crystal display panel and a protective panel according to Embodiment 3 of the present invention.

FIG. 25 is a cross-sectional view of a liquid crystal display panel and parallax barrier panel having a touch panel according to Embodiment 4 of the present invention.

FIG. 26 is a cross-sectional view of a liquid crystal display panel, a parallax barrier panel, and a protective panel according to Embodiment 5 of the present invention.

FIG. 27 is a cross-sectional view showing a state in which a step of curing a portion of the adhesive material is performed by radiating ultraviolet rays towards the overlapping portion of the adhesive material in a method of manufacturing a liquid crystal display device according to Embodiment 6 of the present invention.

FIG. 28 is a cross-sectional view showing a state in which a step of curing a portion of the adhesive material is performed by radiating ultraviolet rays towards the overlapping portion of the adhesive material in a method of manufacturing a liquid crystal display device according to Embodiment 7 of the present invention.

FIG. 29 is a cross-sectional view showing a state in which a step of curing a portion of the adhesive material is performed by radiating ultraviolet rays towards the overlapping portion of the adhesive material in a method of manufacturing a liquid crystal display device according to Embodiment 8 of the present invention.

FIG. 30 is a plan view in which a step of coating an adhesive material is performed such that the adhesive material is coated onto the parallax barrier panel in a planar form in a method of manufacturing a liquid crystal display device according to Embodiment 9 of the present invention.

FIG. 31 is a cross-sectional view showing a state in which a step of curing a portion of the adhesive material is performed by radiating ultraviolet rays on the overlapping portion of the adhesive material.

FIG. 32 is a plan view of a parallax barrier panel showing a state in which the overlapping portion of the adhesive material has been cured.

FIG. 33 is a cross-sectional view showing a state prior to the liquid crystal display panel being attached to the parallax barrier panel.

FIG. 34 is a cross-sectional view showing a state in which a step of curing all of the adhesive material has been performed.

### DETAILED DESCRIPTION OF EMBODIMENTS

### Embodiment 1

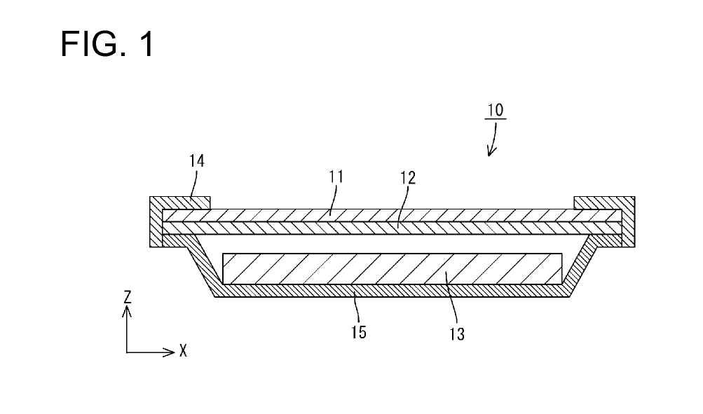

Embodiment 1 of the present invention will be described with reference to FIGS. 1 to 18. In the present embodiment, a liquid crystal display device 10 (display device) and a method of manufacturing the same will be described as an example. The drawings indicate an X axis, a Y axis, and a Z axis in a portion of the drawings, and each of the axes indicates the same direction for the respective drawings. The upper side in FIG. 1 is the front side and the lower side is the rear side.

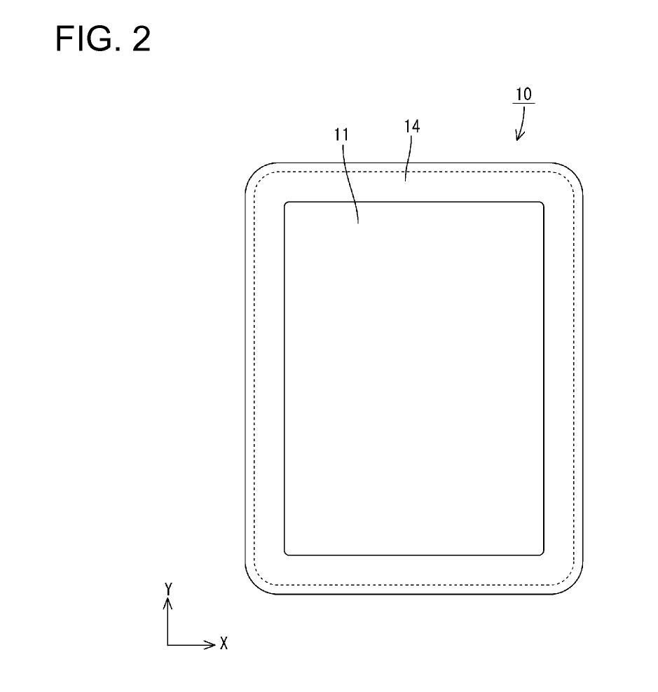

First, the structure of the liquid crystal display device 10 will be explained. As shown in FIGS. 1 and 2, the liquid crystal display device 10 includes: a liquid crystal display panel 11 (display panel) that displays images, the liquid crystal display panel 11 having a rectangular shape overall in a plan view and being used either in portrait (vertical) or landscape (horizontal) mode; a parallax barrier panel 12 (function panel) having a parallax barrier function; and a backlight device 13 (illumination device) that is an external light source that radiates light towards the liquid crystal display panel 11 and the parallax barrier panel 12. Furthermore, the liquid crystal display device 10 includes a bezel 14 that holds together (sandwiches) the liquid crystal display panel 11 and the parallax barrier panel 12, and a case 15 that houses the backlight device 12 while being attached to the bezel 14.

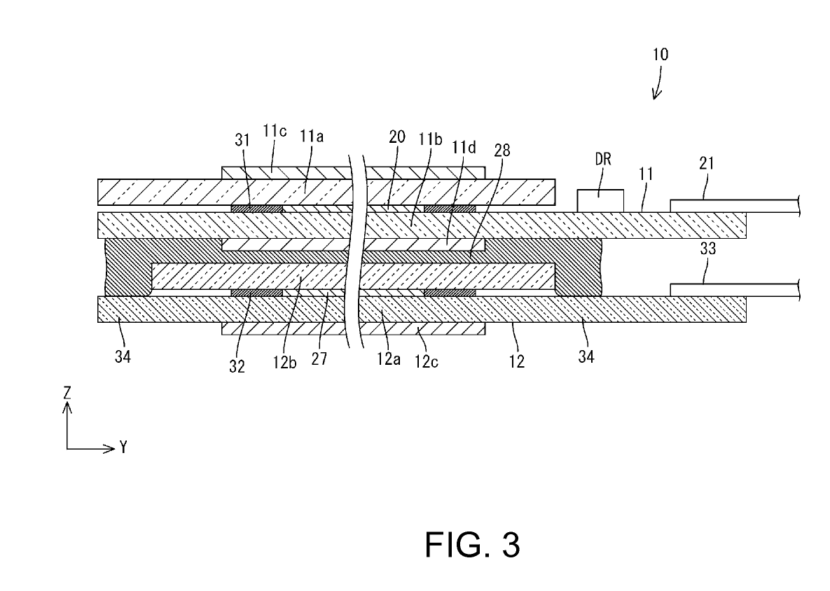

Of these, as shown in FIG. 3, the liquid crystal display panel 11 and the parallax barrier panel 12 are attached together integrally by an adhesive material 28 therebetween, the liquid crystal display panel 11 and the parallax barrier panel 12 have plate surfaces facing each other, the liquid crystal display panel 11 being disposed towards the front (light exiting side; viewer side), the parallax barrier panel 12 being disposed towards the rear (backlight device 13 side; side opposite to the light exiting side). The adhesive material 28 is made of a photocurable resin having sufficient light transmittance so as to be almost transparent, and is a photocurable adhesive material. The photocurable resin included in the adhesive material 28 has the property of being cured (increased viscosity) when irradiated with light of a certain wavelength, and in the present embodiment, this photocurable resin is specifically an ultraviolet curable resin material cured by ultraviolet rays (UV rays). In other words, the adhesive material 28 of the present embodiment is an ultraviolet curable adhesive material. The liquid crystal display device 10 according to the present embodiment can be used in various electronic devices such as portable information devices (including electronic books and PDAs), mobile telephones (including smartphones), laptops (including tablet PCs and the like), digital photo frames, and portable gaming devices. Thus, the screen size of the liquid crystal display panel 11 and the parallax barrier panel 12 constituting the liquid crystal display device 10 is between a few inches and ten or more inches, for example, and generally falls under the category of mid to small size.

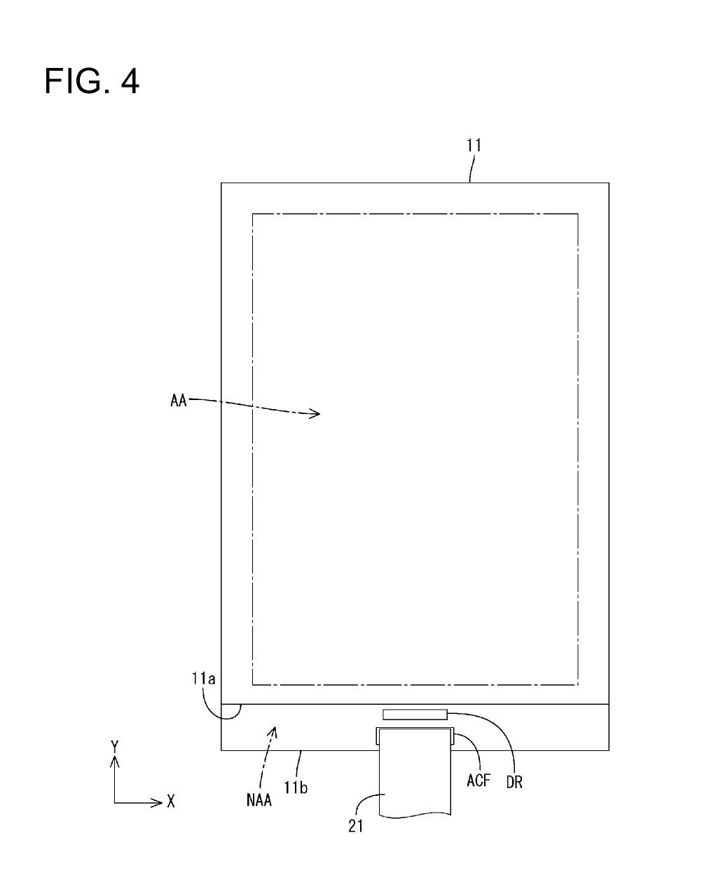

The liquid crystal display panel 11 will be described. As shown in FIGS. 3, 4, and 7, the liquid crystal display panel 11 includes a pair of mostly transparent (transmitting light) glass substrates 11a and 11b, which are rectangular, and a liquid crystal layer 20 including liquid crystal molecules interposed (sandwiched) between the substrates 11a and 11b, liquid crystal molecules being a substance that changes in optical properties due to an applied electric field, and the substrates 11a and 11b are attached together by a sealing member 31 having a frame shape in a plan view and maintaining a gap (cell thickness) equal to the thickness of the liquid crystal layer 20. The pair of substrates 11a and 11b are made of non-alkali glass, which contains almost no alkali, for example, and are specifically “EAGLE XG (registered trademark)” made by Corning. Of the substrates 11a and 11b, the front substrate 11a (CF substrate 11a) has a longer side dimension that is shorter than that of the rear substrate 11b (array substrate 11b), and the substrate 11a is attached to the substrate 11b such that three sides (other shorter side edge (upper side in FIG. 4) and a pair of longer side edges) to the exclusion of one shorter side edge (lower side in FIG. 4) coincide in position. As shown in FIG. 4, the liquid crystal display panel 11 has a display region AA (surrounded by the one-dot-chain line in FIG. 4) where images are displayed, and a non-display region NAA having a substantially frame shape surrounding the display region AA and where images are not displayed. The sealing member 31 is disposed on an inner edge of the non-display region NAA adjacent to the display region AA, and surrounds the display region AA. As shown in FIG. 3, the outer surfaces of the substrates 11a and 11b respectively have a pair of front and rear polarizing plates 11c and 11d attached thereto. The polarizing plates 11c and 11d are slightly smaller than the respective substrates 11a and 11b but have a larger size than the display region AA (region surrounded by the sealing member 31). The rear plate surface of the substrate 11b and the polarizing plate 11d disposed towards the rear, that is the surface facing the parallax barrier panel 12 is provided with the already described adhesive material 28. The adhesive 28 is disposed so as to be further out than at least the rear polarizing plate 11d and the display region AA, but the outer edges of the adhesive 28 are disposed further inside than the outer edges of the substrate 11b. As shown in FIG. 2, when the liquid crystal display panel 11 is used in portrait mode, the longer side direction (Y axis direction) coincides with the vertical direction (up-and-down direction) as seen by the viewer, and the shorter side direction (X axis direction) coincides with the horizontal direction (left-and-right direction; direction in which both eyes LE and RE are aligned) as seen by the viewer, and when the liquid crystal display panel 11 is used in landscape mode, the longer side direction coincides with the horizontal direction as seen by the viewer and the shorter side direction coincides with the vertical direction as seen by the viewer.

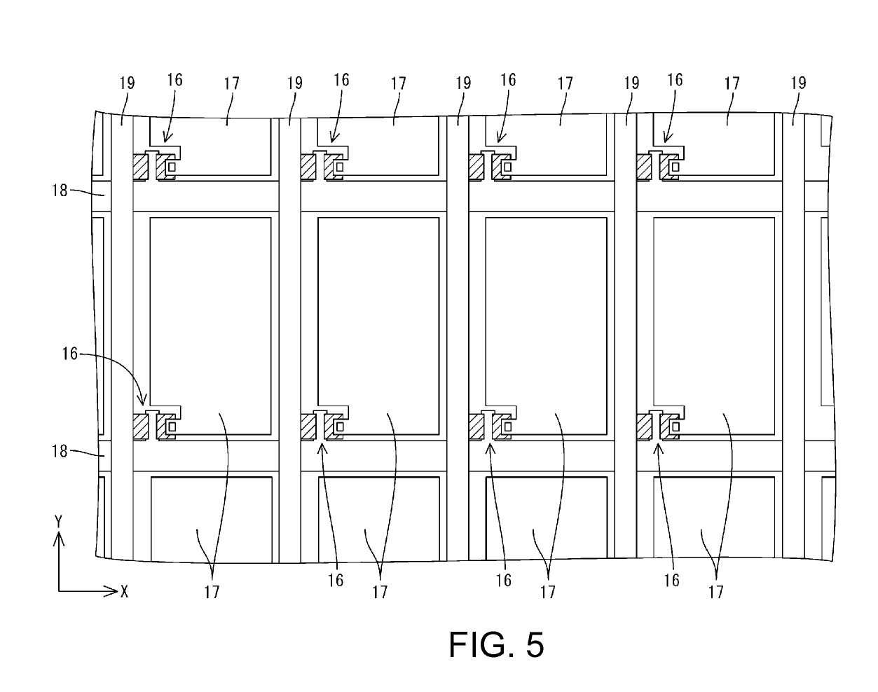

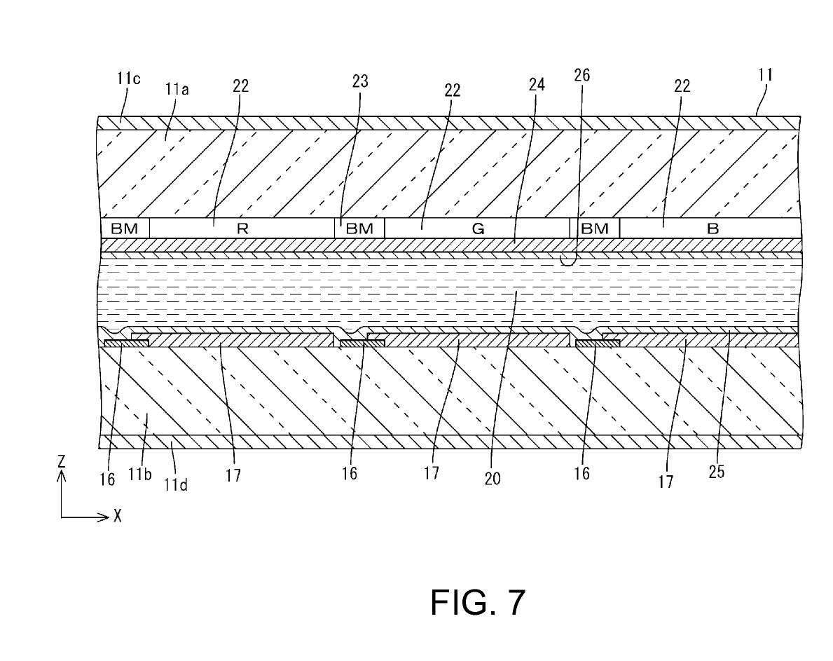

Of the two substrates 11a and 11b, one on the front side (front surface side) is a CF substrate 11a, and the other on the rear side (rear surface side) is an array substrate 11b. As shown in FIGS. 5 and 7, the display region AA in the inner surface of the array substrate 11b (plate surface facing the liquid crystal layer 20 and the CF substrate 11a) is provided with many TFTs 16 (thin film transistors), which are switching elements, and pixel electrodes 17 arranged in a matrix, and gate wiring lines 18 and source wiring lines 19 surround each of the TFTs 16 and the pixel electrodes 17 to form a grid pattern. The pixel electrodes 17 are made of a mostly transparent light-transmissive conductive material such as ITO (indium tin oxide). On the other hand, the gate wiring lines 18 and the source wiring lines 19 are both made of a light-shielding metal such as copper or titanium. The gate wiring lines 18 and the source wiring lines 19 are respectively connected to the gate electrodes and the source electrodes of the TFTs 16, and the pixel electrodes 15 are connected to the drain electrodes of the TFTs 16, respectively. As shown in FIG. 4, the gate wiring lines 18 and the source wiring lines 19 are drawn to the non-display region NAA on the inner surface of the array substrate 11b, and a driver DR for driving the liquid crystal is connected to terminals formed on the ends of the gate wiring lines 18 and the source wiring lines 19. The driver DR is mounted by the COG (chip on glass) method on one edge of the array substrate 11b in the longer side direction, and can send a driving signal to the wiring lines 18 and 19 connected thereto. One end of the flexible substrate 21 for display is press-connected to a position adjacent to the driver DR on the inner face of the array substrate 11b (non-display region NAA) through an anisotropic conductive film ACF. Another end of the flexible substrate 21 for display is connected to a control substrate that is not shown, and thus, it is possible to send to the driver DR an image signal sent from the control substrate.

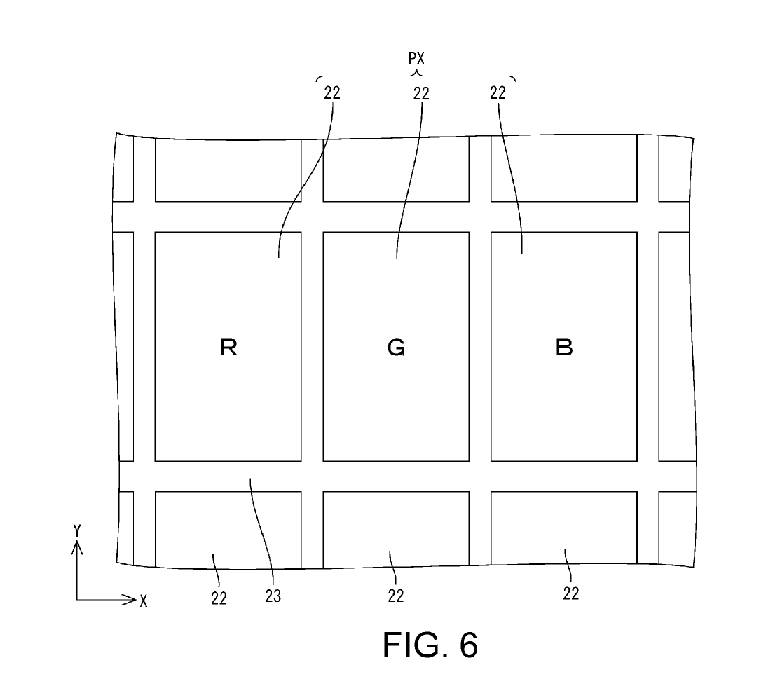

On the other hand, as shown in FIGS. 6 and 7, many color filters are provided in areas of the inner surface of the CF substrate 11a (facing the liquid crystal layer 20 and the array substrate 11b) overlapping the respective pixel electrodes 17 in a plan view on the array substrate 11b. As for the color filters, the colored portions 22 thereof, which are colored R (red), G (green), and B (blue), respectively, are aligned alternately along the X-axis direction. The colored portions 22 have a rectangular shape in a plan view, and the longer side direction and shorter side direction thereof match the longer side direction and shorter side direction of the substrates 11a and 11b, and a plurality of the colored portions 22 are arranged in a matrix in the X axis direction and the Y axis direction on the CF substrate 11a. Between each of the colored portions 22 constituting the color filters, a light-shielding portion 23 (black matrix) is formed in a grid pattern in order to prevent color mixing. The light-shielding portion 23 is positioned over the gate wiring lines 18 and the source wiring lines 19 on the array substrate 11b in a plan view. In the liquid crystal display panel 11, a group of three pixel electrodes 17 respectively corresponding to three colored portions 22 having the colors R, G, and B constitute one pixel PX, which is a display unit, and the pixels PX are arranged in a matrix along the surfaces of the substrates 11a and 11b, or in other words, along the display surface (X axis direction and Y axis direction. As shown in FIG. 7, the surfaces of the respective colored portions 22 and the light-shielding portions 23 are provided with an opposite electrode 24 facing the pixel electrodes 17 on the array substrate 11b. Alignment films 25 and 26, which are disposed to face the liquid crystal layer 20, for orienting the liquid crystal molecules included in the liquid crystal layer 20 are formed on the inner surfaces of the substrates 11a and 11b.

The backlight device 13 will be described in a simple manner prior to describing the parallax barrier panel 12. The backlight device 13 is of a so-called edge-lit (side-lit) type, and includes light sources, a substantially box-shaped chassis for housing the light sources while being open on the front (facing the liquid crystal display panel 11; direction towards which light exits), a light guide member having an edge portion facing the light sources and guiding light from the light sources and emitting this light towards the opening of the chassis (light-exiting portion), and optical members disposed to cover the opening of the chassis. The light emitted from the light sources enters the edge of the light guide member, is propagated inside the light guide member, and then is emitted towards the opening of the chassis, after which it is converted into planar light having an even luminance distribution across a plane by the optical members, and then is emitted towards the liquid crystal display panel 11. The driving of the TFTs 16 in the liquid crystal display panel 11 to selectively control the transmittance of light through the display surface in the liquid crystal display panel 11 allows a prescribed image to be displayed in the display surface. Detailed depictions of the light sources, the chassis, the light guide member, and the optical members will be omitted.

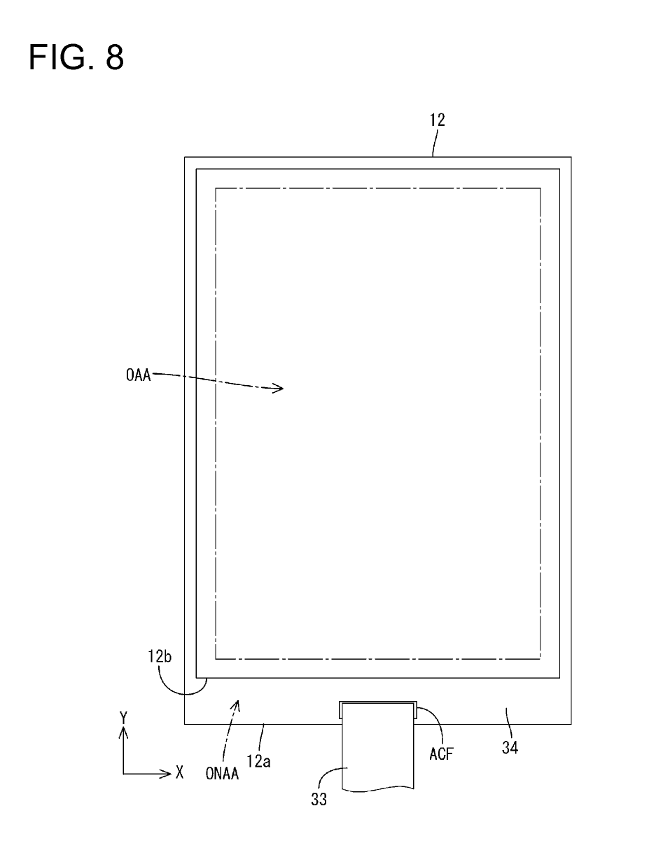

Next, the parallax barrier panel 12 will be described in detail. As shown in FIGS. 3 and 8, the parallax barrier panel 12 includes a pair of transparent (transmitting light) glass substrates 12a and 12b that are rectangular in a plan view, and a liquid crystal layer 27 including liquid crystal molecules interposed (sandwiched) between the substrates 12a and 12b, the liquid crystal molecules being a substance that changes in optical characteristics due to an applied electric field, and the substrates 12a and 12b are attached to each other by a sealing member 32 having a frame-shape in a plan view and maintaining a gap (cell thickness) between the substrates 12a and 12b equal to the thickness of the liquid crystal layer 27. The pair of substrates 12a and 12b are made of non-alkali glass, which contains almost no alkali, for example, and are specifically “EAGLE XG (registered trademark)” made by Corning. As shown in FIG. 8, the parallax barrier panel 12 has a display-overlapping region OAA (area in FIG. 8 surrounded by the one-dot-chain line) overlapping the display region AA of the liquid crystal display panel 11 in a plan view, and a non-display-overlapping region ONAA overlapping the non-display region NAA of the liquid crystal display panel 11, and the non-display-overlapping region ONAA has a substantially frame shape surrounding the display-overlapping region OAA. The sealing member 32 is disposed on the inner edge of the non-display-overlapping region ONAA adjacent to the display-overlapping region OAA, and surrounds the display-overlapping region OAA.

As shown in FIG. 3, the parallax barrier panel 12 has almost the same display size as the liquid crystal display panel 11 and the parallax barrier panel 12 is attached to the liquid crystal display panel 11 through the adhesive material 28 so as to be aligned therewith. When in portrait mode, the longer side direction (Y axis direction) coincides with the vertical direction (up-and-down direction) as seen by the viewer, and the shorter side direction (X axis direction) coincides with the horizontal direction (left-and-right direction; direction in which the eyes LE and RE are aligned) as seen by the viewer, and when in landscape mode, the longer side direction matches the horizontal direction as seen by the viewer and the shorter side direction matches the vertical direction as seen by the viewer. Of the pair of substrates 12a and 12b constituting the parallax barrier panel 12, as shown in FIGS. 3 and 8, the second substrate 12b towards the front (facing the liquid crystal display panel 11 and the adhesive material 28) is slightly smaller than the rear first substrate 12a in a plan view, and specifically, the shorter side dimensions (size in the X axis direction) and the longer side dimensions (size in the Y axis direction) are both relatively smaller. The front second substrate 12b is slightly smaller than the CF substrate 11a of the liquid crystal display panel 11 in a plan view. Therefore, the first substrate 12a has a projection 34 that projects further outward than the outer edge of the smaller second substrate 12b. The projection 34 has a substantially frame shape that is vertically long so as to surround the second substrate 12b in a plan view. Also, the rear first substrate 12a is almost the same size in a plan view as the array substrate 11b of the liquid crystal display panel 11. As shown in FIG. 3, the surface of the second substrate 12b facing the front (opposite to the side facing the liquid crystal layer 27), or in other words, the surface facing the liquid crystal display panel 11 is provided with an adhesive material 28. The adhesive 28 disposed over a wider area in a plan view than at least the front second substrate 12b, and the outer edge thereof is disposed to the inside than the outer edge of the first substrate 12a. On the other hand, a polarizing plate 12c is attached to the outer surface of the first substrate 12a facing the rear (surface opposite to that facing the liquid crystal layer 27).

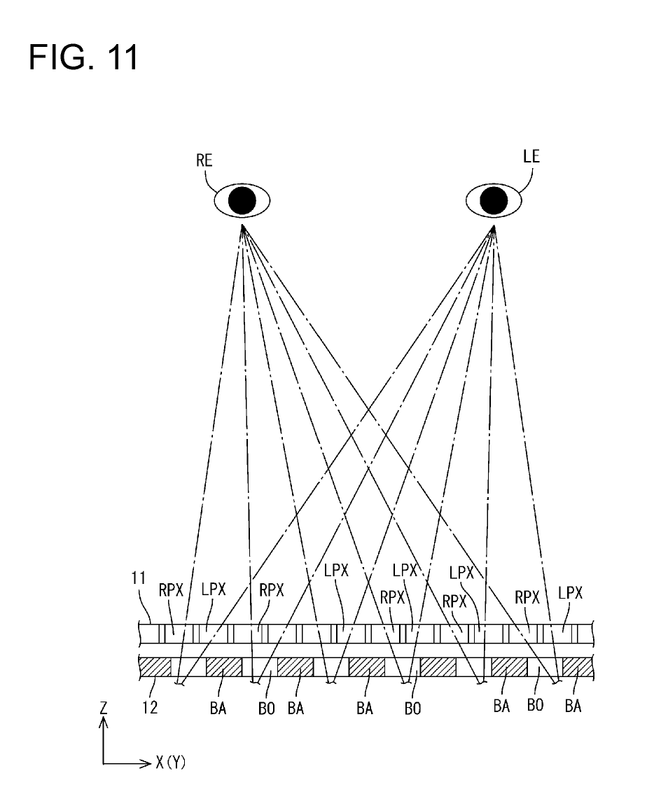

The parallax barrier panel 12 has a parallax barrier pattern 29 that splits by parallax the image displayed on the display surface of the liquid crystal display panel 11 to allow a three dimensional image to be seen by the viewer, and functions as a parallax barrier. In the parallax barrier panel 12, a prescribed voltage is applied by the parallax barrier pattern 29 to the liquid crystal layer 27 so as to control the orientation of the liquid crystal molecules based on the voltage value and the light transmittance of the liquid crystal layer 27, and can form a barrier portion BA, the details of which will be described later), and thus, the image displayed in the pixels PX of the liquid crystal display panel 11 are split by parallax, allowing the image to be seen by the viewer as a three dimensional image (see FIG. 11). In other words, the parallax barrier panel 12 is a switching liquid crystal panel that can switch between displaying a two dimensional image and a three dimensional image in the display surface of the liquid crystal display panel 11 by actively controlling the light transmittance of the liquid crystal layer 27.

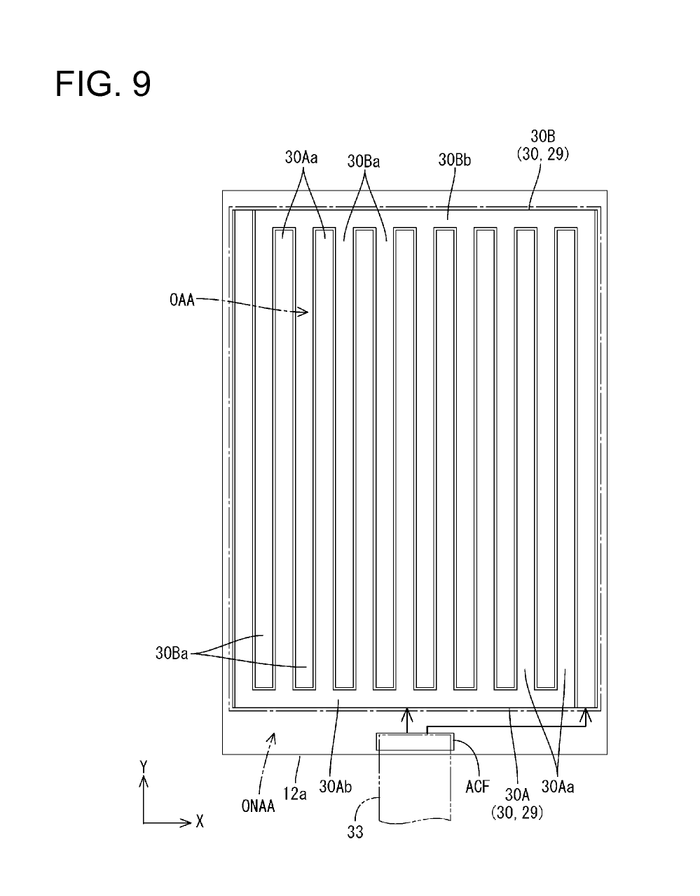

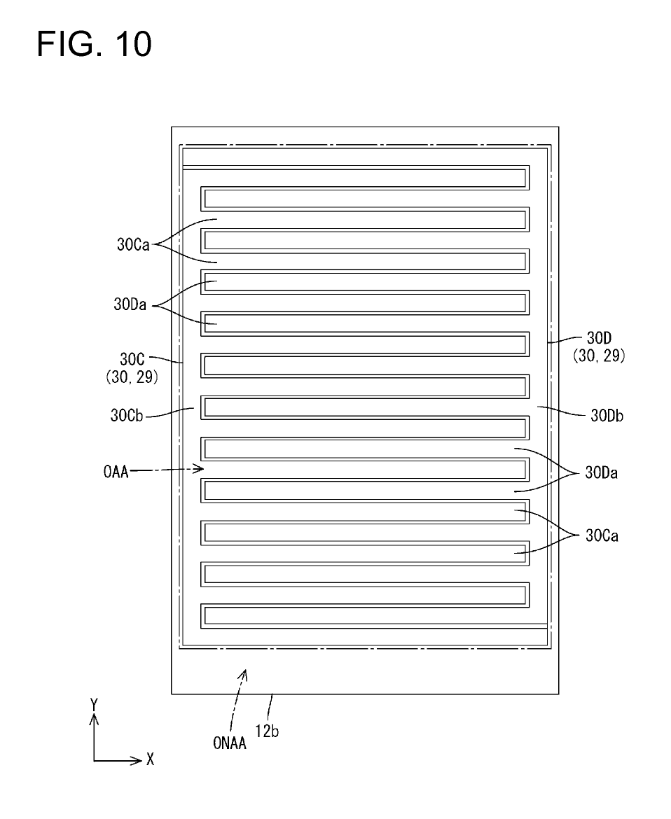

As shown in FIGS. 9 and 10, the respective inner surfaces (facing the liquid crystal layer 27) of the pair of substrates 12a and 12b constituting the parallax barrier panel 12 respectively have transparent electrode portions 30 facing each other and constituting the parallax barrier pattern 29. The transparent electrode portions 30 are made of an almost transparent transmissive conductive material such as ITO, like the pixel electrodes 17 of the liquid crystal display panel 11, and have a display-overlapping region OAA in the parallax barrier panel 12. As a result, in the display-overlapping region OAA of the parallax barrier panel 12, the light transmittance is maintained at a high level, and it is possible for light to be transmitted therethrough with very little light loss. Pairs of the transmissive electrode portions 30 are provided respectively on the rear first substrate 12a and the front second substrate 12b, and the transmissive electrode portions 30 provided on the first substrate 12a are the first transmissive electrode portion 30A and the second transmissive electrode portion 30B, whereas the transmissive electrode portions provided on the second substrate 12b are the third transmissive electrode portion 30C and the fourth transmissive electrode portion 30D.

As shown in FIG. 9, the first transmissive electrode portion 30A and the second transmissive electrode portion 30B respectively have a comb shape and interlock with each other in a plan view. Specifically, the first transmissive electrode portion 30A and the second transmissive electrode portion 30B respectively have a plurality of belt-shaped portions 30Aa and 30Ba that have a substantially uniform width and extend along the longer side direction (Y axis direction) of the first substrate 12a (to form a stripe pattern), and connecting portions 30Ab and 30Bb that respectively connect the edges of the belt-shaped portions 30Aa and 30Ba while extending along the shorter side direction (X axis direction). Therefore, in the display-overlapping region OAA of the first substrate 12a, the belt-shaped portions 30Aa and the first transmissive electrode portion 30A and the belt-shaped portions 30Ba and the second transmissive electrode portion 30B are arranged alternately in the shorter side direction (X axis direction).

On the other hand, as shown in FIG. 10, the third transmissive electrode portion 30C and the fourth transmissive electrode portion 30D respectively have a comb shape and interlock with each other in a plan view. Specifically, the third transmissive electrode portion 30C and the fourth transmissive electrode portion 30D respectively have a plurality of belt-shaped portions 30Ca and 30Da having a belt-shape and a uniform width (to form stripes) while extending in the shorter side direction (X axis direction) of the second substrate 12b and being arranged in the longer side direction (Y axis direction) of the second substrate 12b, the third transmissive electrode portion 30C and the fourth transmissive electrode portion 30D also respectively having connecting portions 30Cb and 30Db that connect edges of the respective belt-shaped portions 30Ca and 30Da and extending in the longer side direction (Y axis direction). Therefore, in the display-overlapping region OAA of the second substrate 12b, the belt-shaped portions 30Ca of the third transmissive electrode portion 30C and the belt-shaped portions 30Da of the fourth transmissive electrode portion 30D are disposed alternately along the longer side direction (Y axis direction). As shown in FIGS. 3, 9, and 10, with the substrates 12a and 12b being attached together, the respective belt-shaped portions 30Ab and 30Bb of the first transmissive electrode portion 30A and the second transmissive electrode portion 30B are disposed to face each other across the liquid crystal layer 27 while being perpendicular to the length direction thereof. Alignment films (not shown) for orienting the liquid crystal molecules including the liquid crystal layer 27 are formed on the inner surfaces of the substrates 12a and 12b while facing the liquid crystal layer 27.

As shown in FIG. 9, one edge in the longer side direction of the first substrate 12a has a terminal portion (not shown) drawn from the first transmissive electrode portion 30A and the second transmissive electrode portion 30B, one end of the flexible substrate 33 for the barrier is connected to this terminal portion. The flexible substrate 33 for the barrier is press-connected to the terminal portion through the anisotropic conductive film ACF. Another end of this flexible substrate 33 for the barrier is connected to a control substrate that is not shown, and thus, it is possible to transmit a barrier driving signal from the control substrate to the first transmissive electrode portion 30A and the second transmissive electrode portion 30B. As shown in FIG. 8, the terminal portion and the flexible substrate 33 for the barrier are disposed in the non-display-overlapping region ONAA in the parallax barrier panel 12. The third transmissive electrode portion 30C and the fourth transmissive electrode portion 30D provided on the second substrate 12b are electrically connected to the terminal portion on the first substrate 12a by conductive columnar portions (not shown) penetrating the liquid crystal layer 27 and connecting together the substrates 12a and 12b, and the barrier driving signals can be sent from the terminal portion.

The parallax barrier panel 12 of the present embodiment has a maximum light transmittance in the liquid crystal layer 27 when the potential difference between the first transmissive electrode portion 30A and second transmissive electrode portion 30B, and the third transmissive electrode portion 30C and fourth transmissive electrode portion 30D is 0, for example, and can be used in a so-called normally white mode switching liquid crystal panel that can transmit the maximum amount of light over the entire region when the potential difference is 0. Furthermore, driving of the parallax barrier panel 12 of the present embodiment is controlled by applying a prescribed potential to the respective electrode portions 30A to 30D, and it is possible for the viewer to see a three dimensional image in both portrait and landscape modes.

Specifically, when the liquid crystal display device 10 is used in portrait mode, the second transmissive electrode portion 30B, the third transmissive electrode portion 30C, and the fourth transmissive electrode portion 30D are fed a reference potential, but the first transmissive electrode portion 30A is fed a prescribed potential different from the reference potential, for example. As a result, while no potential difference occurs between the second transmissive electrode portion 30B, the third transmissive electrode portion 30C, and the fourth transmissive electrode portion 30D, a potential difference does occur between the first transmissive electrode portion 30A, and the third transmissive electrode portion 30C and fourth transmissive electrode portion 30D. Thus, as shown in FIG. 11, of the liquid crystal layer 27 in the parallax barrier panel 12, barrier portions BA having the smallest light transmittance to block light, for example, are formed in areas overlapping the first transmissive electrode portion 30A in a plan view, whereas in areas overlapping the second transmissive electrode portion 30B in a plan view, barrier openings BO having the maximum light transmittance so as to transmit light therethrough are formed in areas overlapping the second transmittance electrode portion 30B in a plan view. A plurality of the barrier portions BA and a plurality of the barrier openings BO are in a stripe pattern along the Y axis direction in a manner similar to that of the respective belt-shaped portions 30Ab and 30Bb of the first transmissive electrode portion 30A and the second transmissive electrode portion 30B, and are aligned alternately in the X axis direction. The direction in which the barrier portions BA and the barrier openings BO are aligned match the direction of alignment of the eyes LE and RE (X axis direction) of the viewer when in portrait mode, and thus, if the respective pixels PX aligned in the X axis direction in the liquid crystal display panel 11 in this state are controlled to be driven such that a left eye image and a right eye image are alternately displayed, the right eye image (right eye pixels RPX) and the left eye image (left eye pixels LPX) have viewing angles respectively controlled by the barrier portions BA, and through the barrier openings BO, these images are respectively and separately seen by the right eye RE and the left eye LE of the viewers. As a result, binocular parallax is attained in portrait mode and the viewer can see a three dimensional image.

On the other hand, when the liquid crystal display device 10 is used in landscape mode, the first transmissive electrode portion 30A, the second transmissive electrode portion 30B, and the fourth transmissive electrode portion 30D are fed the reference potential whereas the third transmissive electrode portion 30C is fed a prescribed potential differing from the reference potential. As a result, no potential difference emerges between the first transmissive electrode portion 30A, the second transmissive electrode portion 30B, and the fourth transmissive electrode portion 30D, but a potential difference does occur between the third transmissive electrode portion 30C, and the first transmissive electrode portion 30A and second transmissive electrode portion 30B. Thus, as shown in FIG. 11, in the liquid crystal layer 27 of the parallax barrier panel 12, areas overlapping the third transmissive electrode portion 30C in a plan view have a minimum light transmittance, for example, and a barrier portion BA blocking light is formed here, whereas areas overlapping the fourth transmissive electrode portion 30D have the maximum light transmittance, thus forming the barrier openings BO. A plurality of the barrier portions BA and a plurality of the barrier openings BO are formed in a stripe shape extending along the X axis direction in a manner similar to the respective belt-shaped portions 30Ca and 30Da of the third transmissive electrode portion 30C and the fourth transmissive electrode portion 30D, and extend alternately in the Y axis direction. The direction in which the barrier portions BA and the barrier openings BO are aligned match the direction of alignment of the eyes LE and RE (Y axis direction shown in parentheses in FIG. 11) of the viewer when in landscape mode, and thus, if the respective pixels PX aligned in the Y axis direction in the liquid crystal display panel 11 in this state are controlled to be driven such that a left eye image and a right eye image are alternately displayed, the right eye image (right eye pixels RPX) and the left eye image (left eye pixels LPX) have viewing angles respectively controlled by the barrier portions BA, and through the barrier openings BO, these images are respectively and separately seen by the right eye RE and the left eye LE of the viewers. As a result, binocular parallax is attained in landscape mode and the viewer can see a three dimensional image.

In a liquid crystal display device 10 that can switch three dimensional display between portrait mode and landscape mode, it is preferable that a gyrosensor (not shown) be installed, that the orientation of the liquid crystal display device 10 (portrait or landscape) be detected by the gyrosensor, and that the driving of the liquid crystal display panel 11 and the parallax barrier panel 12 be automatically switched between portrait mode and landscape mode depending on this detected signal. Also, when displaying a two dimensional image to the viewer, then by feeding the reference potential to all transmissive electrode portions 30A to 30D, for example, no potential difference occurs between the first transmissive electrode portion 30A, the second transmissive electrode portion 30B, the third transmissive electrode portion 30C, and the fourth transmissive electrode portion 30D, and the transmittance in the entire liquid crystal layer 27 is set to the maximum. As a result, no barrier portions BA blocking light are formed in the parallax barrier panel 12. Therefore, no parallax is formed in the image displayed in the pixels PX in the liquid crystal display panel 11, and thus, the viewer sees a two dimensional image. Alternatively, a configuration may be adopted in which no potential is fed to any of the electrode portions 30A to 30D, thus forming no potential difference between the first transmissive electrode portion 30A, the second transmissive electrode portion 30B, the third transmissive electrode portion 30C, and the fourth transmissive electrode portion 30D.

The liquid crystal display device 10 of the present embodiment has the configuration described above, and a manufacturing method therefor will be described next in detail. The liquid crystal display device 10 is manufactured by the following steps: a step of manufacturing the liquid crystal panel 11 and the parallax barrier panel 12; a step of coating the liquid adhesive material 28 on the parallax barrier panel 12, among the liquid crystal display panel 11 and the parallax barrier panel 12; attaching together the liquid crystal display panel 11 and the parallax barrier panel 12; a step of partial curing in which an overlapping portion 35 of the adhesive material 28 overlapping the outer edge portion of the parallax barrier panel 12; a step of adjusting a position of the liquid crystal display panel 11 and the parallax barrier panel 12 in the surface direction, a step of curing the entire adhesive material 28; and a step of attaching polarizing plates 11c and 12c on the respective outer surfaces of the liquid crystal display panel 11 and the parallax barrier panel 12. Below, the respective steps will be explained in detail.

In the step of manufacturing the panels, the liquid crystal display panel 11 and the parallax barrier panel 12 are respectively manufactured in different manufacturing lines. After various components are sequentially layered on the respective substrates by the known photolithography method, the liquid crystal display panel 11 is manufactured by attaching together the substrates 11a and 11b with the liquid crystal layer 20 and the sealing member 31 interposed therebetween (see FIGS. 4 to 7). In the step of manufacturing the liquid crystal display panel 11, a polarizing plate 11d is attached to the rear outer surface of the array substrate 11b, which is the rear substrate of the liquid crystal display panel 11, but the front polarizing plate 11c is not attached. On the other hand, after sequentially layering the respective components on the substrates 12a and 12b by the known photolithography method, the parallax barrier panel 12 is manufactured by attaching together the respective substrates 12a and 12b with the liquid crystal layer 27 and the sealing member 32 interposed therebetween (see FIGS. 8 to 10). In the step of manufacturing the parallax barrier panel 12, the parallax barrier panel 12 is manufactured such that the first substrate 12a has a projection 34 by being formed slightly larger than the second substrate 12b in a plan view. In the step of manufacturing the parallax barrier panel 12, a polarizing plate 12c is not attached to the parallax barrier panel 12. In the step of manufacturing the panels, corresponding flexible substrates 21 and 33 and drivers DR are respectively connected (mounted) to the panels 11 and 12.

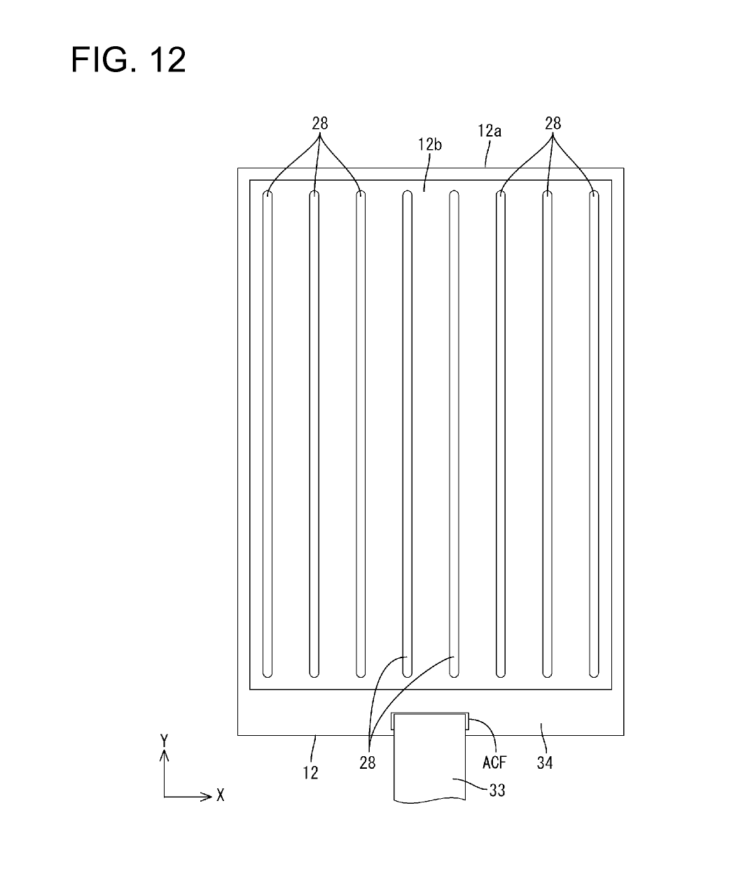

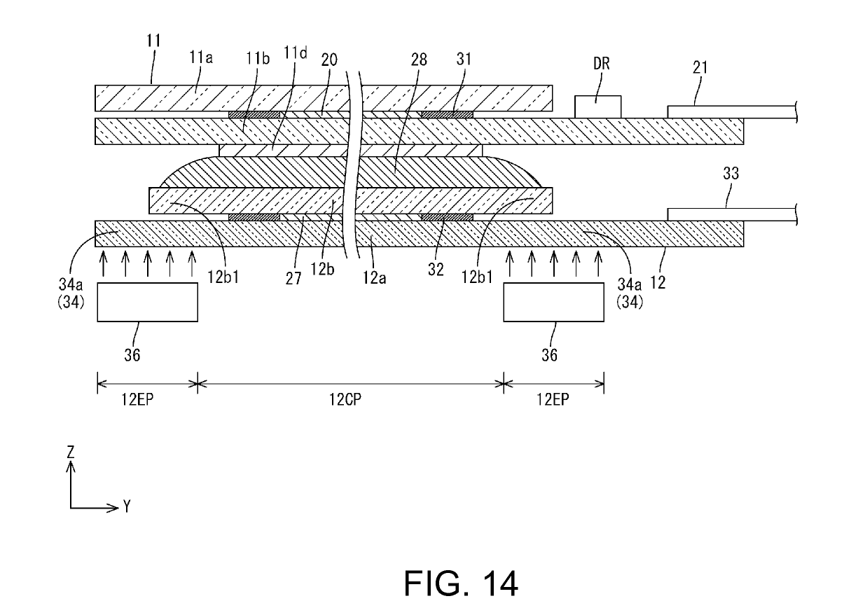

As shown in FIG. 12, in the step of coating the adhesive material, the liquid adhesive material 28 is coated in portions of the front surface of the second substrate 12 of the parallax barrier panel 12. Specifically, the adhesive material 28 is coated by ejecting it onto the second substrate 12b from a nozzle of a coating device (not shown) to form a stripe pattern extending in the longer side direction (Y axis direction) of the second substrate 12b, a plurality of lines of the adhesive material 28 being coated to be aligned intermittently in the shorter side direction (X axis direction) of the second substrate 12b. The adhesive material 28 is coated more on a central portion 12CP than on an outer edge portion 12EP (described later) of the parallax barrier panel 12 (see FIG. 14). The amount of adhesive material 28 coated in the step of coating the adhesive material is adjusted such that when the liquid crystal display panel 11 and the parallax barrier panel 12 are attached together in the following attaching step, a large amount of the adhesive material 28 in the central portion of the opposing surfaces of the panels 11 and 12 spread but do not leak outside the edge of the panels 11 and 12. The specific gap between the panels 11 and 12 (thickness of the adhesive material 28) is set to be approximately 50 μm, for example. The step of coating the adhesive material is performed in a lighting environment that does not have any ultraviolet radiation such that unwanted curing of the adhesive material 28 does not occur.

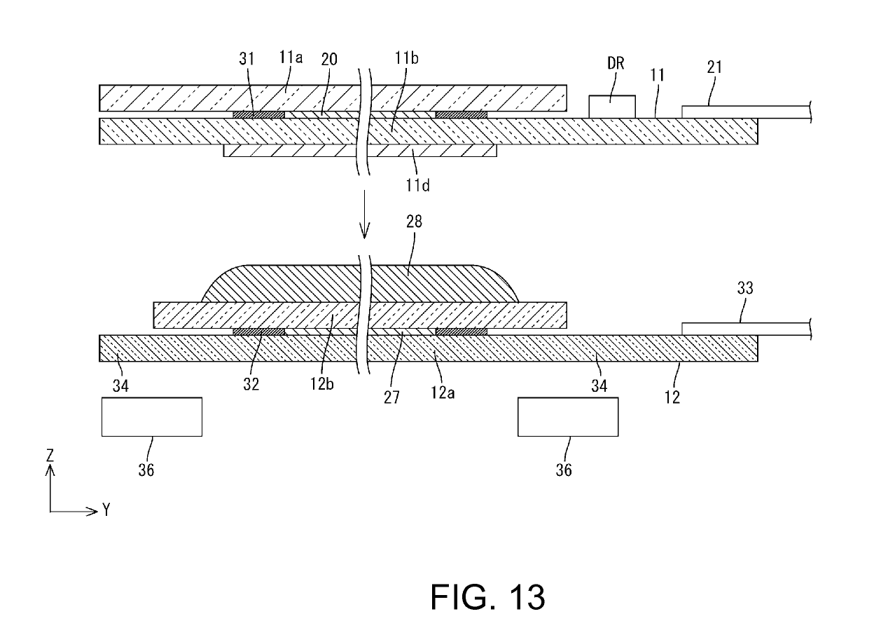

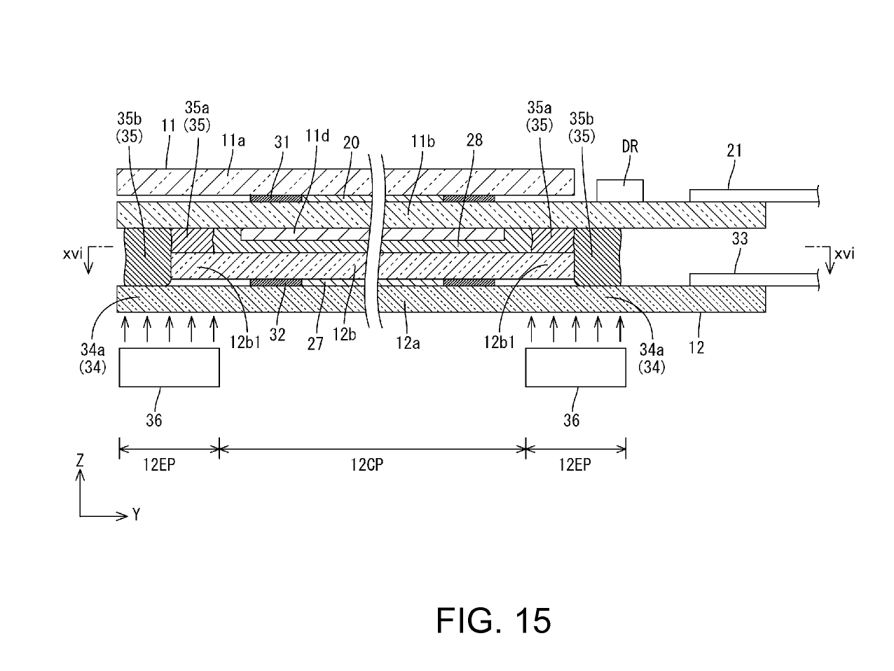

As shown in FIG. 13, the liquid crystal display panel 11 is disposed to the front of the parallax barrier panel 12 coated with the liquid adhesive material 28, the two panels are roughly positioned with respect to each other in the X axis direction and the Y axis direction while causing the liquid crystal display panel 11 to approach the parallax barrier panel 12 in the Z axis direction, and the two panels are attached to each other at a prescribed pressure. As shown in FIG. 14, when the liquid crystal display panel 11 is attached to the parallax barrier panel 12, the adhesive material 28 coated in a stripe pattern is spread by pressure from the liquid crystal display panel 11, and thus, is spread evenly in a planar shape between the array substrate 11b (rear polarizing plate 11d) of the liquid crystal display panel 11 and the second substrate 12b of the parallax barrier panel 12. At this time, depending on the amount of adhesive material 28 present and the amount of pressure applied to the adhesive material 28 from the liquid crystal display panel 11, the adhesive material 28 spreads beyond the outer edge step of the second substrate 12b of the parallax barrier panel 12 and reaches the space between the projection 34 of the first substrate 12a and the array substrate 11b (see FIG. 15). The space between the projection 34 of the first substrate 12a and the array substrate 11b is greater than the space between the second substrate 12b and the array substrate 11b, and thus, it is possible to retain a sufficient amount of the adhesive material 28 that has spread beyond the step of the outer edge of the second substrate 12b, and thus, the adhesive material 28 is less susceptible to leaking from the outer edges of the respective panels 11 and 12.

The partial curing step is performed simultaneously to the attaching step described above. As shown in FIG. 14, the partial curing step is performed by radiating ultraviolet rays to cure the adhesive material 28 from a partial illumination device 36 disposed to face the outer edge portion 12EP of the parallax barrier panel 12 while performing the attaching step. The outer edge portion 12EP of the parallax barrier panel 12 as described here includes an outer end portion 12b1 of the second substrate 12b, and an inner end portion 34a that surrounds the outer end portion 12b of the second substrate 12b of the projection 34 of the first substrate 12a. The partial illumination device 36 has a substantially frame shape along the outer edge portion 12EP of the parallax barrier panel 1, and overlap the outer edge portion 12EP of the parallax barrier panel 12 in a plan view. Specifically, the partial illumination device 36 is disposed in an area of the parallax barrier panel 12 from the outer end portion 12b1 of the second substrate 12b to the inner end portion 34a of the projection 34 of the first substrate 12a. The partial illumination device 36 is designed such that the amount of ultraviolet rays radiated per unit area on the parallax barrier panel 12 (adhesive material 28) is substantially even throughout the partial illumination device 36. In the attaching step described above, the liquid adhesive material 28 is pressed to spread towards the outer edge from the central areas of the panels 11 and 12, and reaches areas overlapping the outer edge portion 12EP in a plan view, but as shown in FIG. 15, the overlapping portion 35 of the adhesive material 28 overlapping the outer edge portion 12EP in a plan view is irradiated with the ultraviolet rays from the partial illumination device 36, and is thereby cured. By radiating ultraviolet rays from the partial illumination device 36 simultaneously to the start of the attaching step, for example, it is possible to more reliably cure the overlapping portion 35 of the adhesive material 28 that has reached areas overlapping the outer edge portion 12EP after having spread as a result of the attaching step.

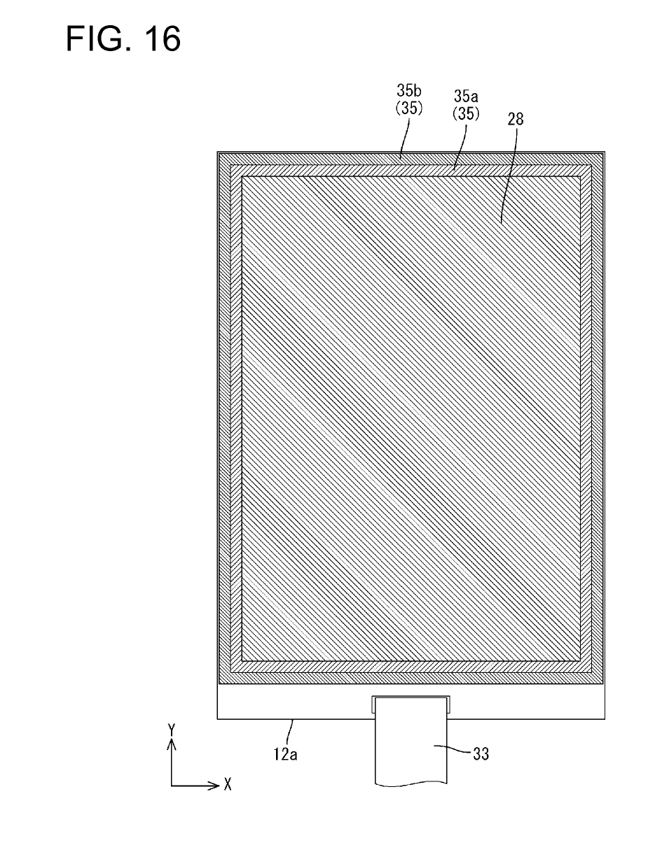

As shown in FIGS. 15 and 16, by curing the overlapping portion 35, which is the outer edge portion of the adhesive material 28, the frame-shaped cured overlapping portion 35 blocks in all areas the highly fluid portion (liquid portion) of the adhesive material 28 that has not yet been cured, located towards the center. As a result, even if the amount of adhesive material 28 is excessive due to individual differences in the coating device during the step of coating the adhesive material, or even if the pressure applied to the panels 11 and 12 by an attaching device (pressurizing device) during the attaching step is excessive, the portion of the adhesive material 28 that has not yet been cured is not susceptible to leaking outside from the outer edges of the panels 11 and 12. Therefore, it is less likely for the outer appearance of the device to be ruined or for display quality to be diminished due to unwanted adhesive material 28 sticking to the outer surfaces of the liquid crystal display panel 11 and the parallax barrier panel 12, for example. The timing when the partial illumination device 36 begins radiation of ultraviolet rays may be after a prescribed period of time has elapsed since the attaching step; this timing can be modified as appropriate as long as it is before the adhesive material 28 reaches an area overlapping the outer edge portion 12EP.

As shown in FIG. 15, the ultraviolet rays emitted by the partial illumination device 36 are radiated on the adhesive material 28 after passing through either or both of the substrates 12a and 12b constituting the parallax barrier panel 12. Of the overlapping portion 35, the portion overlapping the outer end portion 12b1 of the second substrate 12b of the parallax barrier panel 12 in a plan view is an inner edge portion 35a located towards in the inside, and the portion overlapping the inner edge portion 34a of the projection 34 of the first substrate 12a of the parallax barrier panel 12 in a plan view is the outer edge portion 35b located towards the outside; whereas the inner edge portion 35a is irradiated with ultraviolet rays that have passed respectively through the substrates 12a and 12b, the outer edge portion 35b is irradiated with ultraviolet rays that have passed only through the projection 34 of the first substrate 12a. Thus, the amount of ultraviolet rays radiated on the inner edge portion 35a is relatively small due to some of the ultraviolet rays being absorbed or reflected by the two substrates 12a and 12b, but the amount of ultraviolet rays radiated on the outer edge portion 35b is relatively large due to no absorption or reflection of the ultraviolet rays by the second substrate 12b. Therefore, if the amount of time that ultraviolet rays are radiated on the inner edge portion 35a and the outer edge portion 35b is the same, then the degree of curing of the inner edge portion 35a is relatively small, whereas the degree of curing of the outer edge portion 35b is relatively large. The “degree of curing” here refers to how much curing has progressed in the high fluidity liquid adhesive material 28 due to ultraviolet irradiation, and more specifically refers to the degree of decrease in fluidity and degree of increase in viscosity. As a result, the adhesive material 28 has a stepwise increase in degree of curing (increase in viscosity, decrease in fluidity) in the order of the central non-cured portion (liquid portion), the inner edge portion 35a of the overlapping portion 35, and the outer edge portion 35b. Thus, stress resulting from contraction due to curing in the boundary between the non-cured central portion and the overlapping portion 35 is mitigated, and therefore, the adhesive material 28 is not susceptible to residual stress. If residual stress occurs in the adhesive material 28, residual stress acts on the liquid crystal display panel 11 to be attached, which can negatively affect display, and thus, by mitigating the occurrence of such residual stress, it is possible to maintain a high display quality of images displayed in the liquid crystal display panel 11. In the partial curing step, the overlapping portion 35 is not completely cured, and is in a semi-cured gel state. Specifically, it is preferable that the curing rate of the overlapping portion 35 be 70% or greater, and specifically, it is possible to set the curing rate of the outer edge portion 35b to be 50% to 70%, for example, and the curing rate of the inner edge portion 35a to be 30% to 50%, for example. Here, the “curing rate” is a ratio of a value measuring a physical property such as viscosity or degree of curing in the adhesive material 28 in relation to a value measuring a physical property such as viscosity or degree of curing of the adhesive material 28 that has been irradiated with ultraviolet rays but has not been cured beyond a certain extent. As a result of the overlapping portion 35 of the adhesive material 28 being in a semi-cured gel state, most of the fluidity thereof is gone, and the overlapping portion 35 does not flow along the surfaces of the respective substrates 11b, 12a, and 12b in contact therewith, but the overlapping portion 35 can elastically deform.

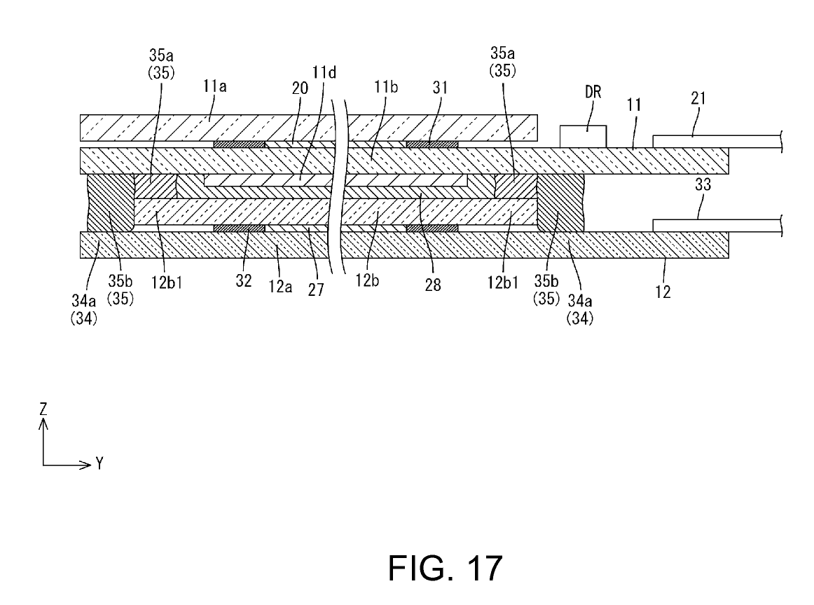

By going through the attaching step and the partial curing step as described above, the panels 11 and 12 attached with a prescribed gap therebetween can be positioned in the position adjusting step that follows. As shown in FIG. 17, the position adjusting step is performed by changing the position of the liquid crystal display panel 11 with respect to the parallax barrier panel 12, for example, along the surface direction, that is, the X axis direction and the Y axis direction. As already described, in the adhesive material 28, the overlapping portion 35 has already been partially cured, but can still elastically deform, and thus, adjusting of the position is allowed by the overlapping portion 35 elastically deforming as the liquid crystal display panel 11 moves relative to the parallax barrier panel 12. By performing this position adjusting step, the panels 11 and 12 can be positioned in the surface direction at a high accuracy, and thus, images displayed in the liquid crystal display panel 11 can be more reliably perceived by the viewer as a three dimensional image by the parallax barrier panel 12.

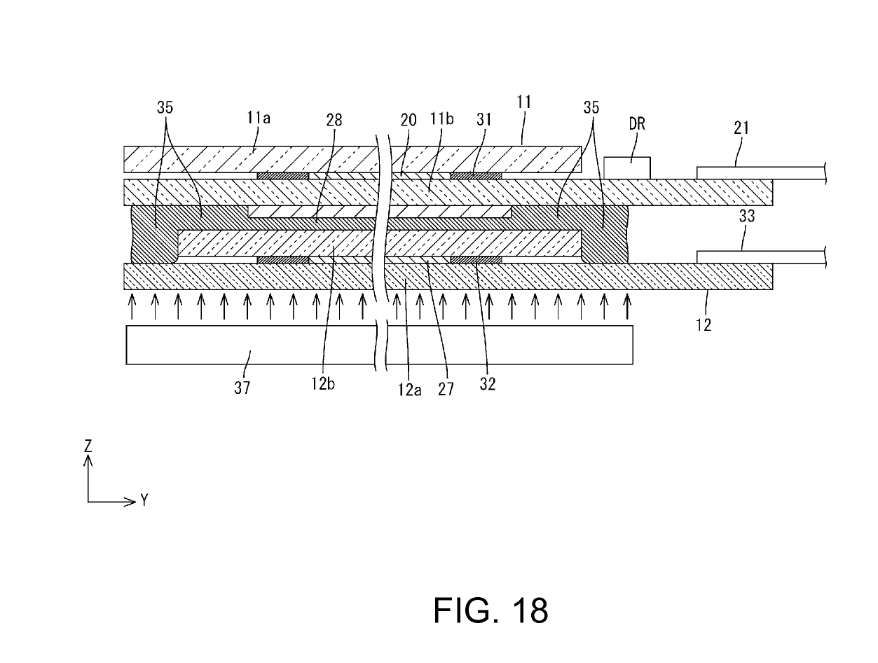

As shown in FIG. 18, in the total curing step, a total illumination device 37 disposed to face the rear of the first substrate 12a of the parallax barrier panel 12 radiates ultraviolet rays to the adhesive material 28. This total illumination device 37 has a substantially plate shape slightly larger than the second substrate 12b of the parallax barrier panel 12 in a plan view, but slightly smaller than the first substrate 12a, and is disposed to overlap the entire second substrate 12b and adhesive material 28 (including the overlapping portion 35). The total illumination device 37 is designed such that the amount of ultraviolet rays radiated per unit area on the parallax barrier panel 12 (adhesive material 28) is substantially even throughout the total illumination device 37. If ultraviolet rays are radiated from the total illumination device 37 to the adhesive material 28 through the parallax barrier panel 12, the adhesive material 28 is cured, both in the semi-cured overlapping portion 35 and the non-cured portion towards the center. When ultraviolet rays are radiated from the total illumination device 37 until the curing rate is 100% in the entire adhesive material 28, the panels 11 and 12 are completely attached to each other by the adhesive material 28. Then, in the step of attaching polarizing plates, polarizing plates 11c and 12c are respectively attached onto the panels 11 and 12, and thus, the manufacturing of the liquid crystal display device 10 shown in FIG. 3 is completed.

As described above, the method of manufacturing the liquid crystal display device 10 (display device) of the present embodiment includes: a step of coating the liquid adhesive material 28 on the opposing surface of at least one of the liquid crystal display panel 11 (display panel) that displays images and the parallax barrier panel 12 (function panel) to be stacked onto the liquid crystal display panel 11; a step of attaching the liquid crystal display panel 11 to the parallax barrier panel 12 through the adhesive material 28; and a step of partial curing in which the overlapping portion 35 of the adhesive material 28 overlapping in a plan view the outer edge portion 12EP of at least one of the liquid crystal display panel 11 and the parallax barrier panel 12 is cured.

In this manner, in the step of coating the adhesive material, the liquid adhesive material 28 is coated on the opposing surface of at least one of the liquid crystal display panel 11 and the parallax barrier panel 12, and in the subsequent attaching step, the liquid crystal display panel 11 and the parallax barrier panel 12 are attached through the adhesive material 28. The method of manufacturing the liquid crystal display device 10 includes the step of partial curing, and the adhesive material 28 is partially cured by curing the overlapping portion 35 of the adhesive material 28 overlapping in a plan view the outer edge portion 12EP of at least one of the liquid crystal display panel 11 and the parallax barrier panel 12, and thus, the non-cured adhesive material 28 in the center can be blocked by the cured overlapping portion 35. As a result, even if there is variation in the amount of adhesive material 28 coated in the step of coating the adhesive material, or there is variation in pressure applied to the liquid crystal display panel 11 and the parallax barrier panel 12 in the attaching step, the adhesive material 28 is not susceptible to leaking outside from at least one of the outer edges of the liquid crystal display panel 11 and the parallax barrier panel 12. Thus, a situation in which unwanted adhesive material 28 sticks to the outer surface of the liquid crystal display panel 11 or the parallax barrier panel 12, for example, is prevented, thus maintaining high display quality.

Also, in the step of partial curing, the degree of curing of the outer edge portion 35b of the overlapping portion 35 located towards the outside is relatively high, whereas the degree of curing of the inner edge portion 35a of the overlapping portion 35 located towards the inside is relatively low. In this manner, when performing partial curing, the degree of curing becomes higher in the order of the non-cured portion towards the center of the adhesive material 28, the inner edge portion 35a of the overlapping portion 35, and the outer edge portion 35b of the overlapping portion 35, and thus, the degree of curing can be changed in a stepwise fashion. As a result, stress that can result from contraction due to curing at the boundary between the overlapping portion 35 and the non-cured portion towards the center can be eased, and thus, a situation in which residual stress in the adhesive material 28 acts on the liquid crystal display panel 11 to reduce display quality, for example, can be made more difficult.

Also, in the step of coating the adhesive material, a photocurable adhesive material 28 is coated as the adhesive material 28, and in the partial curing step, light to induce curing is radiated on the overlapping portion 35 of the photocurable adhesive material 28. By doing so, in the step of partial curing, light to cure the overlapping portion 35 of the photocurable adhesive material 28 is radiated, thereby partially curing the photocurable adhesive material 28, and thus, the range within which the photocurable adhesive material 28 is cured can be set at a high degree of accuracy, and partial curing of the photocurable adhesive material 28 can be done more reliably. Also, compared to thermosetting adhesive materials, for example, the photocurable adhesive material 28 is more quickly cured, and thus, the cycle time can be reduced.

Also, in the step of coating the adhesive material, an ultraviolet curable adhesive material 28 is coated as the photocurable adhesive material 28, and in the step of partial curing, ultraviolet rays are radiated to cure the overlapping portion 35 of the ultraviolet curable adhesive material 28. In this manner, compared to a case in which a visible light curable adhesive material is used as the photocurable adhesive material, it is relatively easier to take measures to prevent unwanted curing between when the step of coating the adhesive material is performed and the attaching step is performed, and thus, equipment costs and the like can be reduced. Also, the ultraviolet curable adhesive material 28 is more quickly cured, and thus, the cycle time can be even further reduced.

Also, in the step of partial curing, ultraviolet rays are radiated on the overlapping portion 35 through the parallax barrier panel 12. In this manner, compared to a case in which the overlapping portion 35 is irradiated with ultraviolet rays through the liquid crystal display panel, a problem is mitigated in which structures provided in the liquid crystal display panel 11 would be denatured by the ultraviolet rays. As a result, the image displayed on the liquid crystal display panel 11 can have excellent display quality.

The manufacturing method includes a panel manufacturing step, which is a step of manufacturing at least one of the liquid crystal display panel 11 and the parallax barrier panel 12 formed by attaching together a pair of transmissive substrates 12a and 12b, where the first substrate 12a, which is one of the pair of substrates 12a and 12b, has a projection 34 that projects further outward than the second substrate 12b, which is the other substrate. In the partial curing step, the outer edge portion 35b of the overlapping portion 35 towards the outside is irradiated with light through the projection 34 of the first substrate 12a, which is one of the substrates, and the inner edge portion 35a towards the inside is irradiated with light through the pair of substrates 12a and 12b. In this manner, when performing the partial curing step, the outer edge portion 35b is irradiated with light only through the projection 34 of the first substrate 12a, which is one of the substrates, and thus, the amount of light radiated on the outer edge portion 35b is relatively high, and therefore, the degree of curing of the outer edge portion 35b is also high, whereas the inner edge portion 35a is irradiated with light through both of the pair of substrates 12a and 12b, and thus, light is absorbed or reflected by the second substrate 12b, which is the other substrate, and thus, the amount of light radiated on the inner edge portion 35a is relatively low, and therefore the degree of curing is also low. As a result, the degree of curing becomes higher in order of the non-cured portion of the adhesive material 28 towards the center, the inner edge portion 35a of the overlapping portion 35, and the outer edge portion 35b of the overlapping portion 35, and thus, the degree of curing changes in a stepwise fashion. Therefore, the stress that can occur due to contraction from curing in the boundary portion between the non-cured portion in the center and the overlapping portion 35 is mitigated. Therefore, a situation in which residual stress in the adhesive material 28 acts on the liquid crystal display panel 11 to negatively affect display quality, for example, is made unlikely. Furthermore, in the step of partial curing, the amount of light radiated on in the overlapping portion 35 is made different in different portions due to the steps formed between the pair of substrates 12a and 12b, which allows a reduction in cost of the device for radiating light.

In the attaching step, the liquid crystal display panel 11 and the parallax barrier panel 12 are attached together such that the second substrate 12b, which is the other substrate among the pair of substrates 12a and 12b, is positioned facing the adhesive material 28. In this manner, the gap between the liquid crystal display panel 11 and the parallax barrier panel 12 is greater in the area where the projection 34 of the first substrate 12a, which is one of the substrates, is disposed, than in the area where the second substrate 12b, which is the other substrate, is disposed. As a result, the gap where the adhesive material 28 is wider where the inner edge portion 35a of the overlapping portion 35 is disposed than where the outer edge portion 35b is disposed, and thus, leakage of the adhesive material 28 is further mitigated.

The partial curing step is performed simultaneously to the attaching step. In this manner, compared to a case in which the partial curing step is performed separately from the attaching step, the amount of time taken in manufacturing can be reduced.

Also, in the step of coating the adhesive material, the adhesive material 28 is coated on portions of at least one of the opposing surfaces of the liquid crystal display panel 11 and the parallax barrier panel 12, and in the attaching step, by applying pressure on at least one of the liquid crystal display panel 11 and the parallax barrier panel 12, the adhesive material 28 is spread under pressure. In this manner, in the attaching step, by applying pressure on at least one of the liquid crystal display panel 11 and the parallax barrier panel 12, the liquid adhesive material 28 is spread under pressure, and by performing curing on the overlapping portion 35 of the adhesive material 28 spread in this manner, it is possible to block leakage of the non-cured portion in the center to outside of the overlapping portion 35. In this manner, compared to a case in which the adhesive material 28 is coated in a planar form on the opposing surface, the coating efficiency for the adhesive material 28 is better, and is suitable for reducing cycle time or the like.

Also, in the step of coating the adhesive material, the adhesive material 28 is coated in the central portion 12CP surrounded by the outer edge portion 12EP of at least one of the liquid crystal display panel 11 and the parallax barrier panel 12, and in the partial curing step, the adhesive material 28 spread during the attaching step is partially cured before the adhesive material 28 reaches the outer edge portion 12EP of the liquid crystal display panel 11 and the parallax barrier panel 12. In this manner, the overlapping portion 35 of the adhesive material 28 that has reached the outer edge portion 12EP of the liquid crystal display panel 11 and the parallax barrier panel 12 after spreading in the attaching step can be more reliably cured. As a result, it is possible to more reliably prevent leaking of the non-cured portion of the adhesive material 28.

Also, in the partial curing step, the overlapping portion 35 is partially cured. In this manner, even if air bubbles form in the non-cured portion of the adhesive material 28 during attaching, the overlapping portion 35 is partially cured, and thus, the air bubbles in the non-cured portion can be force out through the overlapping portion 35. As a result, air bubbles are less likely to remain in the adhesive material 28, and thus, the display quality of images displayed in the liquid crystal display panel 11 can be maintained at a high level.

Also, after performing the attaching step and the partial curing step, a position adjusting step of adjusting the position of the liquid crystal display panel 11 and the parallax barrier panel 12 along the surface direction is performed. In this manner, because the overlapping portion 35 is partially cured in the partial curing step, it is possible to position the liquid crystal display panel 11 and the parallax barrier panel 12 along the surface direction in the position adjusting step thereafter. As a result, the positioning accuracy of the liquid crystal display panel 11 and the parallax barrier panel 12 can be made high.

Also, in the attaching step, the parallax barrier panel 12 is attached to the liquid crystal display panel 11 as a function panel that can split by parallax images displayed in the liquid crystal display panel 11. In this manner, in the position adjusting step, the positioning accuracy in the surface direction of the liquid crystal display panel 11 and the parallax barrier panel 12 is high, and thus, the function of the parallax barrier panel 12 can more exhibited more suitably, and an excellent three dimensional image can be viewed by a user of the liquid crystal display device 10.

Also, in the partial curing step, curing is performed on the overlapping portion 35 of the adhesive material 28 overlapping the non-display region NAA surrounding the display region AA where images are displayed in the liquid crystal display panel 11. In this manner, even if uneven curing occurs in the overlapping portion 35 of the adhesive material 28 as a result of the partial curing step, the overlapping portion 35 overlaps in a plan view the non-display region NAA in the liquid crystal display panel 11, and thus, deterioration in display quality of images displayed in the display region AA resulting from the overlapping portion 35 is prevented.

### Embodiment 2

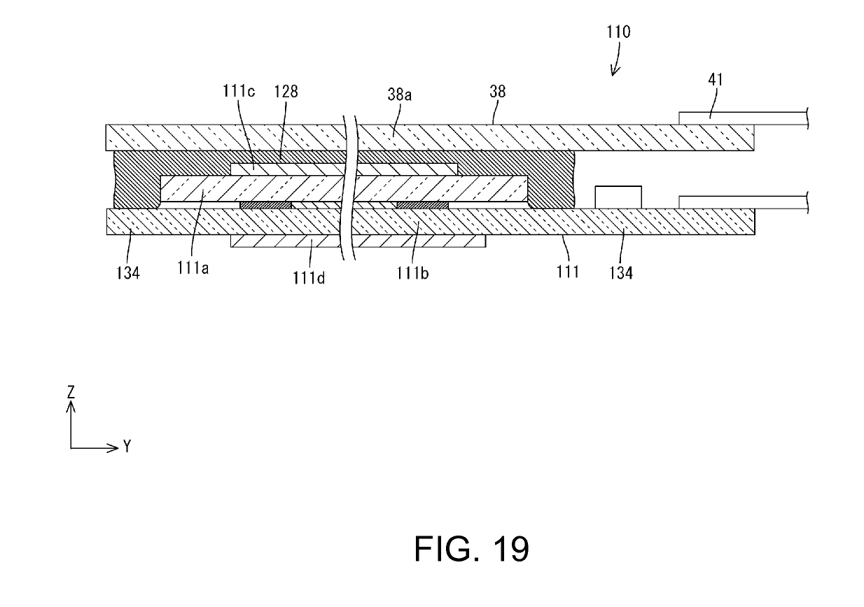

Embodiment 2 of the present invention will be described with reference to FIGS. 19 to 23. In Embodiment 2, the function panel is a touch panel 38. Descriptions of structures, operations, and effects similar to those of Embodiment 1 will be omitted.

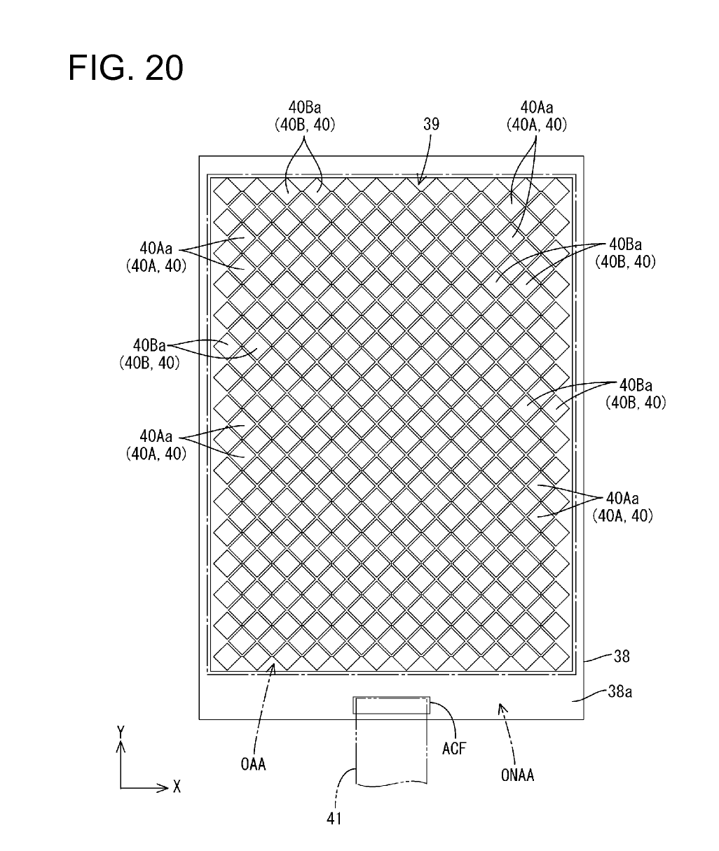

As shown in FIG. 19, instead of the parallax barrier panel 12 in Embodiment 1, a touch panel 38 having a touch panel function to detect a position inputted by the viewer is attached through an adhesive material 128 onto a liquid crystal display panel 111 of the present embodiment. The touch panel 38 layered onto the front of the liquid crystal display panel 111. The touch panel 38 has one mostly transparent glass substrate 38a, and the front outer surface of the substrate 38a, as shown in FIG. 20, has formed thereon transmissive electrode portions 40 for the touch panel constituting a touch panel pattern 39 of a so-called projected capacitive type. The transmissive electrode portions 40 for the touch panel are made of a mostly transparent transmissive conductive material such as ITO, similar to the transmissive electrode portion 30 (transmissive electrode portion for parallax barrier) included in the parallax barrier pattern 29 of Embodiment 1, and the transmissive electrode portions 40 are disposed in a display-overlapping region OAA of the touch panel 38 overlapping the display region AA of the liquid crystal display panel 111. As a result, in the display-overlapping region OAA of the touch panel 38, a high light transmittance is maintained, and it is possible to reduce loss of light passing through the display region AA of the liquid crystal display panel 111. The transmissive electrode portions 40 for the touch panel include a plurality of rows of first transmissive electrode portions 40A for the touch panel extending in the longer side direction (Y axis direction) of the substrate 38a, and a plurality of rows of second transmissive electrode portions 40B for the touch panel extending in the shorter side direction (X axis direction) of the substrate 38a.

As shown in FIG. 20, the first transmissive electrode portions 40A for the touch panel have a plurality of first electrode pads 40Aa having a diamond shape in a plan view and aligned along the Y axis direction, and adjacent first electrode pads 40Aa are connected to each other. A plurality of the first transmissive electrode portions 40A for the touch panel extending along the Y axis direction are arranged in parallel in the X axis direction at a prescribed gap therebetween. By contrast, the second transmissive electrode portions 40B for the touch panel have a plurality of second electrode pads 40Ba having a diamond shape in a plan view and arranged along the X axis direction, and adjacent second electrode pads 40Ba are connected to each other. A plurality of the second transmissive electrode portions 40B for the touch panel extending along the Y axis direction are arranged in parallel in the Y axis direction at a prescribed gap therebetween. Therefore, the substrate 38a has arranged in a matrix thereon a plurality of first electrode pads 40Aa constituting the first transmissive electrode portions 40A for the touch panel and a plurality of second electrode pads 40Ba constituting the second transmissive electrode portion 40B for the touch panel, respectively in the X axis direction and the Y axis direction. The first electrode pads 40Aa and the second electrode pads 40Ba are arranged in the same layer on the substrate 38a, whereas connecting portions between adjacent first electrode pads 40Aa and connecting portions between adjacent second electrode pads 40Ba are kept insulated from each other by an insulating layer (not shown) therebetween.

As shown in FIG. 20, one end of the substrate 38a in the longer side direction has formed thereon a terminal portion (not shown) drawn from the first transmissive electrode portion 40A for the touch panel and the second transmissive electrode portion 40B for the touch panel, and one end of the flexible substrate 41 for the touch panel is connected to this terminal portion. The flexible substrate 41 for the touch panel is connected by pressure to the terminal portion through the anisotropic conductive film ACF. Another end of the flexible substrate 41 for the touch panel is connected to a detection circuit, which is not shown. The terminal portion and the flexible substrate 41 for the touch panel are disposed in the non-display-overlapping region ONAA overlapping the non-display region NAA of the liquid crystal display panel 111 of the touch panel 38. When a finger of a user, which is a conductor, touches or approaches the operating surface of the touch panel 38 in a state in which voltage is sequentially applied to the plurality of rows of first transmissive electrode portions 40A for the touch panel and the plurality of rows of second transmissive electrode portions 40B for the touch panel, then a capacitance is formed between the finger of the user and any of the transmissive electrode portions 40A and 40B for the touch panel, and thus, the capacitance value in the corresponding transmissive electrode portions 40A and 40B for the touch panel differs from the capacitance value of other transmissive electrode portions 40A and 40B for the touch panel. A detection circuit detects differences in capacitance occurring in the transmissive electrode portions 40A and 40B for the touch panel, and the coordinates of the intersection of the corresponding transmissive electrode portions 40A and 40B for the touch panel are input as two dimensional (X axis direction and Y axis direction) position information of the operating position by the user. Therefore, in the touch panel 38, multi-touch operation in which a plurality of locations on the operating surface are simultaneously touched by the user is possible.

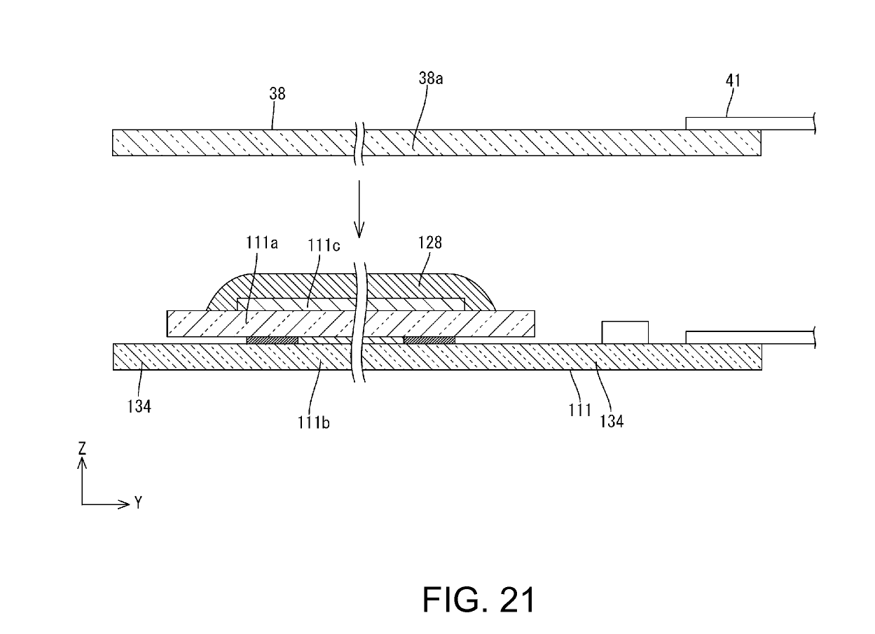

The method of manufacturing the liquid crystal display device 110 obtained by attaching the touch panel 38 of the above configuration to the liquid crystal display panel 111 will be described. First, steps of manufacturing panels are performed to respectively manufacture the panels 38 and 111. Of these, in the method of manufacturing the liquid crystal display panel 111, the liquid crystal display panel 111 is manufactured so as to have a projection 134 due to the array substrate 111b in the rear being formed to be slightly larger in a plan view than the CF substrate 111a in the front. At this stage, the liquid crystal display panel 111 has a front polarizing plate 111c attached thereto, whereas the rear polarizing plate 111d is not yet attached. Next, as shown in FIG. 21, by performing a step of coating an adhesive material, a liquid adhesive material 128 is coated on portions of the CF substrate 111a (front polarizing plate 111c) of the liquid crystal display panel 111.

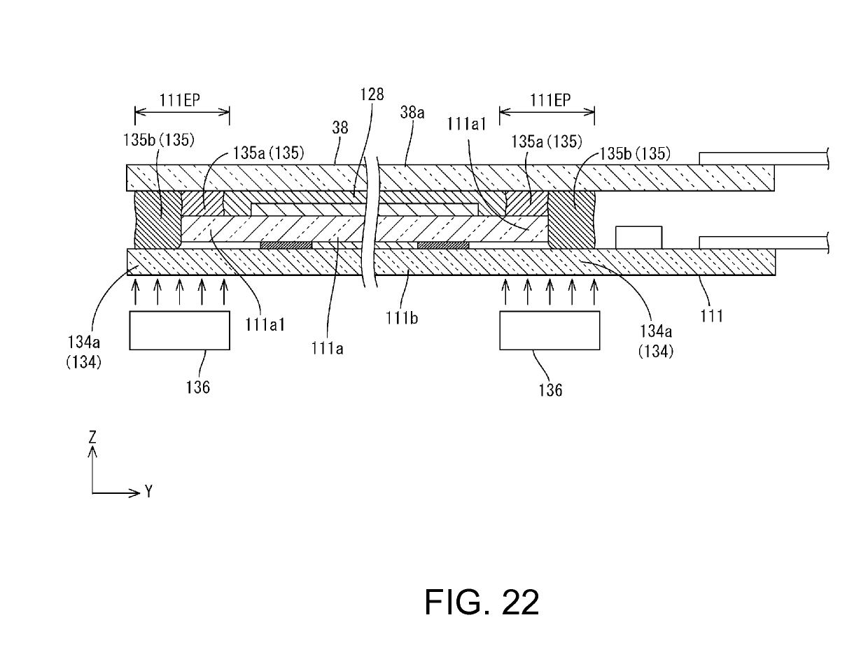

Next, the attaching step and the partial curing step are simultaneously performed. As shown in FIG. 22, when the touch panel 38 is pressed onto the liquid crystal display panel 111 at a prescribed pressure and attached thereto, the liquid adhesive material 128 is spread under pressure. At this time, depending on the amount of adhesive material 128 coated or the pressure applied on the adhesive material 128 by the touch panel 38, the adhesive material 128 moves beyond the step formed at the outer edge of the CF substrate 111a in the liquid crystal display panel 111, and into the space formed between the projection 134 of the array substrate 111b and the substrate 38a of the touch panel 38. As the adhesive material 128 flows as described above, ultraviolet rays for curing the adhesive material 128 are radiated from partial illumination devices 136 disposed to face the rear of the outer edge portion 111EP of the liquid crystal display panel 111. The outer edge portion 111EP of the liquid crystal display panel 111 is defined as including an outer end portion 111a1 of the CF substrate 111a, and an inner end portion 134a of the projection 134 of the array substrate 111b surrounding the outer end portion 111a1 of the CF substrate 111a. This partial illumination device 136 has a frame shape along the outer edge portion 111EP of the liquid crystal display panel 111.

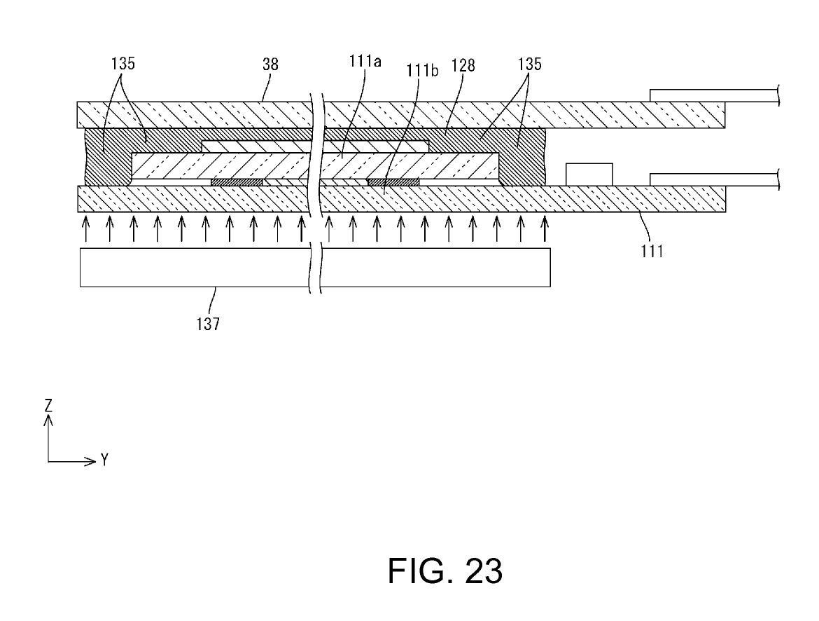

By radiating ultraviolet rays from the partial illumination device 136 to the overlapping portion 135 of the adhesive material 128 overlapping in a plan view the outer edge portion 111EP of the liquid crystal display panel 111, curing of the overlapping portion 135 progresses. At this time, the inner edge portion 135a, which is a portion of the overlapping portion 135 towards the inside, receives less ultraviolet rays due to the ultraviolet rays passing through the pair of substrates 111a and 111b, whereas the outer edge portion 135b, which is the portion of the overlapping portion 135 towards the outside, receives more ultraviolet rays due to the ultraviolet rays passing only through the projection 134 of the array 111b. Therefore, the degree of curing of the adhesive material 128 increases (high viscosity; lower fluidity) in a stepwise fashion in the order of the central non-cured portion (liquid portion), the inner edge portion 135a of the overlapping portion 135, and the outer edge portion 135b, and thus, the stress that could occur in the boundary between the non-cured central portion and the overlapping portion 135 due to contraction from curing is mitigated, and residual stress is unlikely to occur in the adhesive material 128. After the attaching step and the partial curing step are performed as described above, the position adjusting step is performed, and the total curing step is performed thereafter. As shown in FIG. 23, in the total curing step, ultraviolet rays are radiated on the entire adhesive material 128 from the total illumination device 137, and thus, the entirety of the adhesive material 128 is completely cured. Then, the polarizing plate attaching step is performed to attach the polarizing plate 111d to the rear of the liquid crystal display panel 111 to complete the manufacturing of the liquid crystal display device 110.

As described above, in the present embodiment, during the attaching step, the touch panel 38, which can detect an input position by a user on the liquid crystal display device 110, is attached as the function panel to the liquid crystal display panel 111. In this manner, during the attaching step, the liquid crystal display panel 111 and the touch panel 38 are positioned with respect to each other in the surface direction and the positioning accuracy thereof is heightened, and therefore, it is possible for the touch panel 38 to more appropriately exhibit its function, and therefore, it is possible to detect with higher accuracy the position inputted by the user on the liquid crystal display device 110.

### Embodiment 3

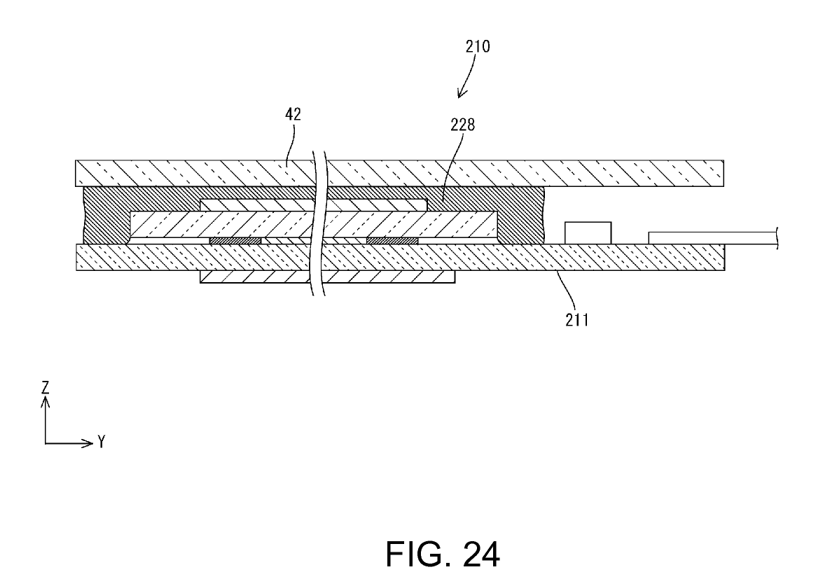

Embodiment 3 of the present invention will be described with reference to FIG. 24. In Embodiment 3, the function panel is a protective panel 42. Descriptions of structures, operations, and effects similar to those of Embodiment 2 will be omitted.

As shown in FIG. 24, a protective panel 42 for protecting the liquid crystal display panel 211 is attached instead of the touch panel 38 of Embodiment 2 to a liquid crystal display panel 211 of the present embodiment through an adhesive material 228. The protective panel 42 layered onto the front of the liquid crystal display panel 211. The protective panel 42 is made of tempered glass, which is almost transparent and has high shock resistance, for example. The method of manufacturing the liquid crystal display device 210 by attaching the protective panel 42 to the liquid crystal display panel 211 is similar to that of Embodiment 2, and thus, detailed descriptions thereof are omitted.

### Embodiment 4

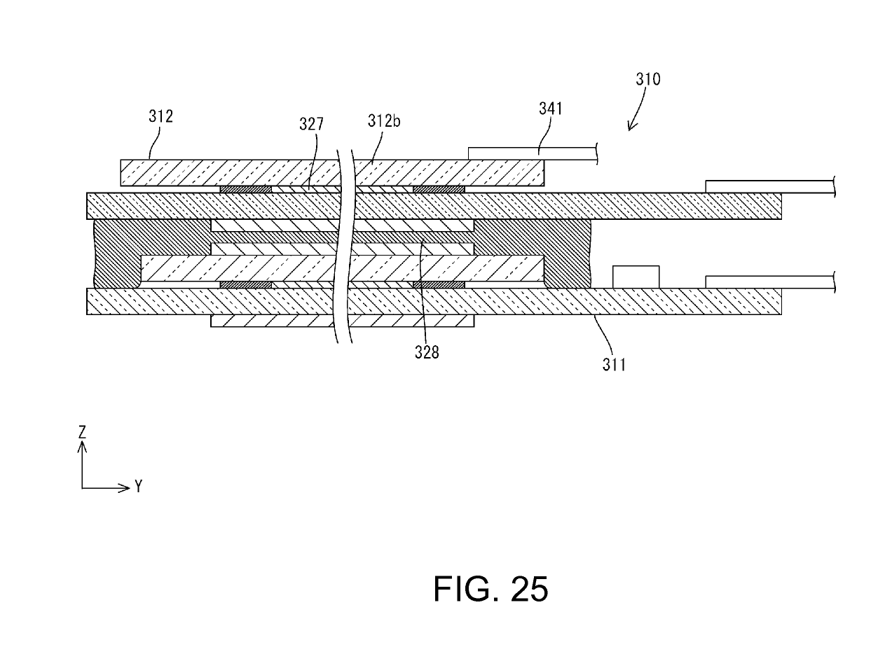

Embodiment 4 of the present invention will be described with reference to FIG. 25. In Embodiment 4, a parallax barrier panel 312 including a touch panel function is used as the function panel. Descriptions of structures, operations, and effects similar to those of Embodiments 1 and 2 will be omitted.

As shown in FIG. 25, instead of the touch panel 38 of Embodiment 2, the liquid crystal display panel 311 of the present embodiment has attached thereto a multi-function parallax barrier panel 312, having a parallax barrier function and a touch panel function, through an adhesive material 328. The parallax barrier panel 312 has a parallax barrier pattern (not shown) similar to that in Embodiment 1, and is layered onto the front of the liquid crystal display panel 311. The outer surface of the second substrate 312b (opposite to the side facing the liquid crystal layer 327), which is the front substrate of the parallax barrier panel 312, has formed thereon a touch panel pattern (not shown) similar to that of Embodiment 2, and is connected to a flexible substrate 341 for the touch panel. As a result, the parallax barrier panel 312 of the present embodiment has a parallax barrier function allowing a viewer to perceive a three dimensional image by splitting by parallax the image displayed on the liquid crystal display panel 311, and a touch panel function (position detection function) for detecting an input position by the viewer.

The method of manufacturing the liquid crystal display device 310 by attaching the parallax barrier panel 312 to the liquid crystal display panel 311 is similar to that of Embodiment 2, and thus, detailed descriptions thereof are omitted.

### Embodiment 5

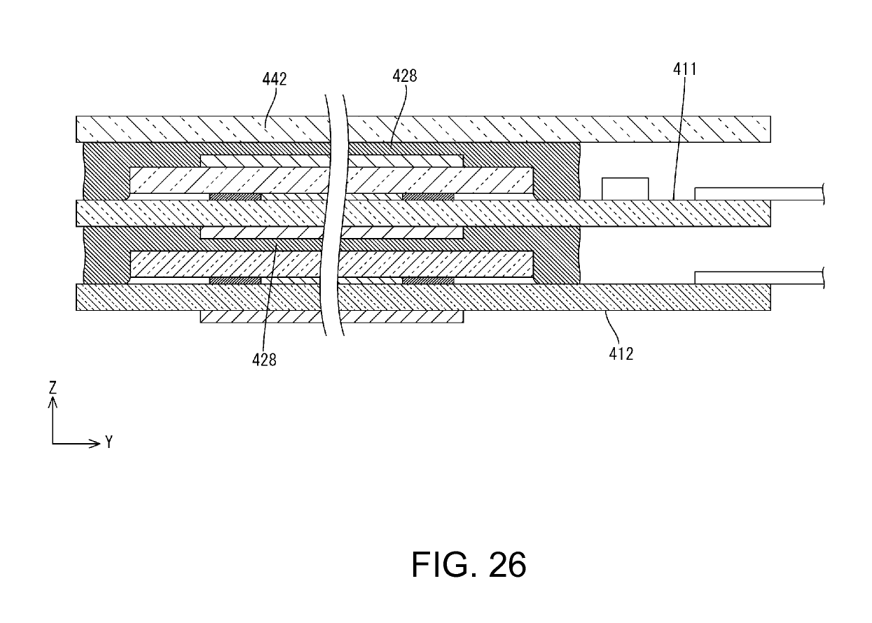

Embodiment 5 of the present invention will be described with reference to FIG. 26. In Embodiment 5, a parallax barrier panel 412 and a protective panel 442 are used as function panels. Descriptions of structures, operations, and effects similar to those of Embodiments 1 and 3 will be omitted.

As shown in FIG. 26, the parallax barrier panel 412 is attached through an adhesive material 428 to the rear of the liquid crystal display panel 411 of the present embodiment, and the protective panel 442 is attached through an adhesive material 428 to the front of the liquid crystal display panel 411. The method and structure of attaching the parallax barrier panel 412 and the liquid crystal display panel 411 of the present embodiment is similar to Embodiment 1. The method and structure of attaching the protective panel 442 and the liquid crystal display panel 411 of the present embodiment is similar to Embodiment 3. Whether the parallax barrier panel 412 or the protective panel 442 is attached first onto the liquid crystal display panel 411 can be selected as appropriate.

### Embodiment 6

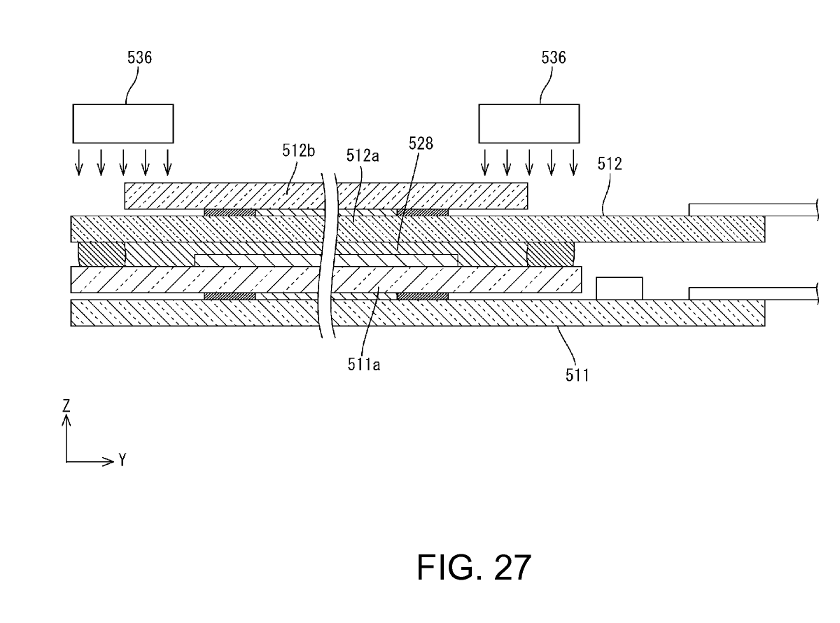

Embodiment 6 of the present invention will be described with reference to FIG. 27. In Embodiment 6, the arrangement of a liquid crystal display panel 511 and a parallax barrier panel 512 is modified, and the partial illumination device 536 used in the partial curing step is modified. Descriptions of structures, operations, and effects similar to those of Embodiment 1 will be omitted.

As shown in FIG. 27, the liquid crystal display panel 511 of the present embodiment is layered on the rear of the parallax barrier panel 512. An adhesive material 528 is disposed between the CF substrate 511a of the liquid crystal display panel 511 and the first substrate 512a of the parallax barrier panel 512. Meanwhile, in the partial curing step, the partial illumination device 536 is disposed to the front of the parallax barrier panel 512, and the adhesive material 528 is irradiated with ultraviolet rays through either or both of substrates 512a and 512b constituting the parallax barrier panel 512. Even with such a configuration, operations and effects similar to those of Embodiment 1 can be attained.

### Embodiment 7

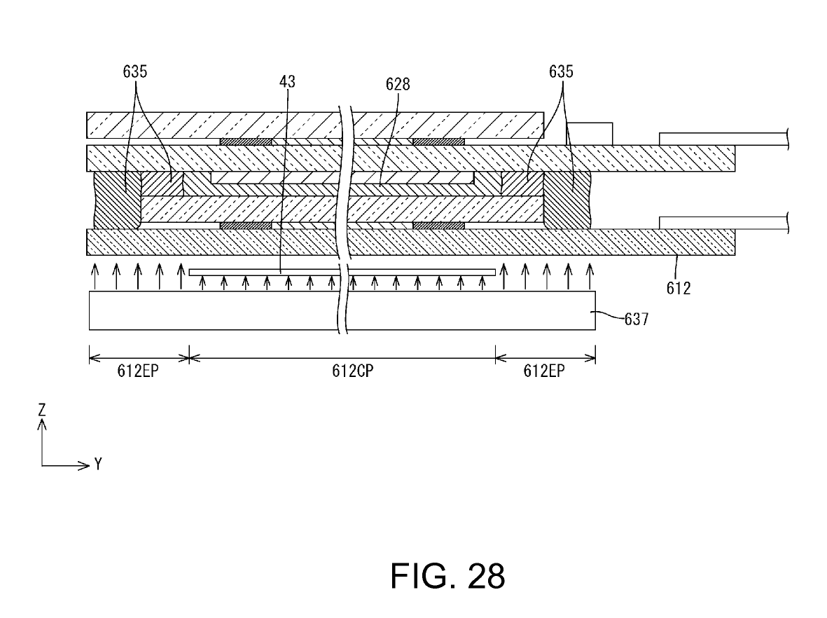

Embodiment 7 of the present invention will be described with reference to FIG. 28. In Embodiment 7, during the partial curing step, a total illumination device 637 is used. Descriptions of structures, operations, and effects similar to those of Embodiment 1 will be omitted.

As shown in FIG. 28, in the partial curing step of the present embodiment, partial curing is performed using the total illumination device 637 used in the total curing step to be performed later. Specifically, in the partial curing step, a light-shielding mask 43 blocking at least ultraviolet rays is interposed between the parallax barrier panel 612 and the total illumination device 637. This light-shielding mask 43 has a plate shape over a range overlapping in a plan view a central portion 612CP of the parallax barrier panel 612 farther to the center than an outer edge portion 612EP. Therefore, of the ultraviolet rays emitted by the total illumination device 637, those traveling towards the central portion 612CP of the parallax barrier panel 612 are blocked by the light-shielding mask 43, and those traveling towards the outer edge portion 612EP are radiated on an overlapping portion 635 of the adhesive material 628 through the outer edge portion 612EP without being blocked by the light-shielding mask 43. In this manner, the total illumination device 637 can be used both during the partial curing step and the total curing step, which eliminates the need for the partial illumination device, thereby reducing equipment costs.

### Embodiment 8

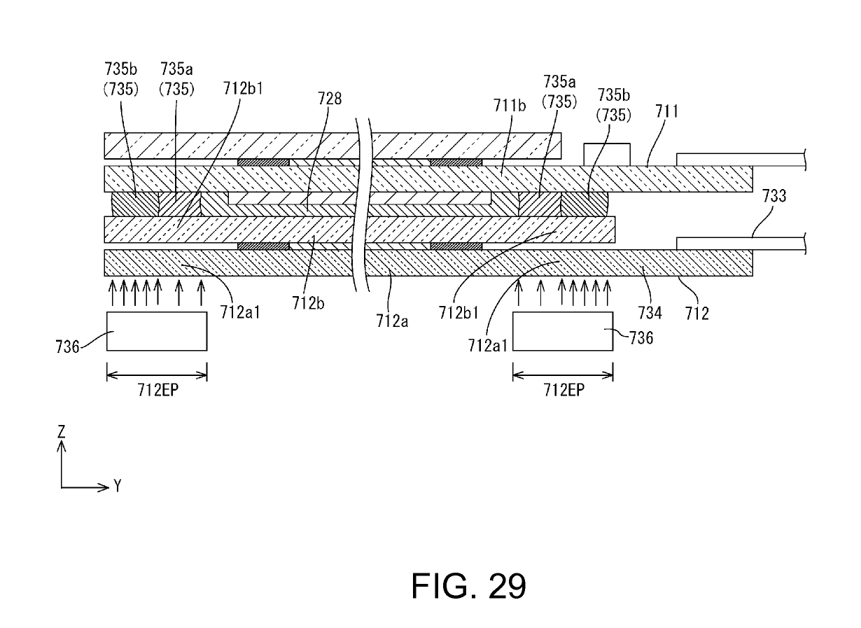

Embodiment 8 of the present invention will be described with reference to FIG. 29. In Embodiment 8, the size of a second substrate 712b of the parallax barrier panel 712 is modified, and the partial illumination device 736 used in the partial curing step is modified. Descriptions of structures, operations, and effects similar to those of Embodiment 1 will be omitted.

As shown in FIG. 29, the second substrate 712b of the parallax barrier panel 712 of the present embodiment has a shorter long side dimension than a first substrate 712a to the rear, and the first substrate 712a is attached to the second substrate 712b such that three sides (pair of longer side edges and one shorter side edge on the left side in FIG. 29) thereof match, the side not matching being the edge having thereon a flexible substrate 733 for the barrier (right side in FIG. 29). Therefore, a projection 734 of the first substrate 712a protrudes outward from the second substrate 712b only on the shorter side having thereon the flexible substrate 733 for the barrier. The outer edge portion 712EP of the parallax barrier panel 712 includes an outer end portion 712b1 of the second substrate 712b, and a portion 712a1 of the first substrate 712a overlapping in a plan view the outer end portion 712b1 of the second substrate 712b. Therefore, the overlapping portion 735 of the adhesive material 728 is disposed in the entirety of the space between the second substrate 712b and the array substrate 711b of the liquid crystal display panel 711.

In the partial curing step performed simultaneously to the step of attaching the parallax barrier panel 712 having this structure to the liquid crystal display panel 711, a partial illumination device 736 emitting different amounts of ultraviolet rays depending on the region is used. The partial illumination device 736 emits a small amount of ultraviolet rays in portions overlapping in a plan view the inner edge portion 735a of the overlapping portion 735 of the adhesive material 728, whereas it emits a larger amount of ultraviolet rays in portions overlapping in a plan view the outer edge portion 735b. In FIG. 29, the number of arrows above the partial illumination device 736 indicates the amount of ultraviolet rays emitted. In this manner, the degree of curing between the inner edge portion 735a and the outer edge portion 735b of the overlapping portion 735 can be changed in a stepwise fashion without using a step in the parallax barrier panel 712.

### Embodiment 9

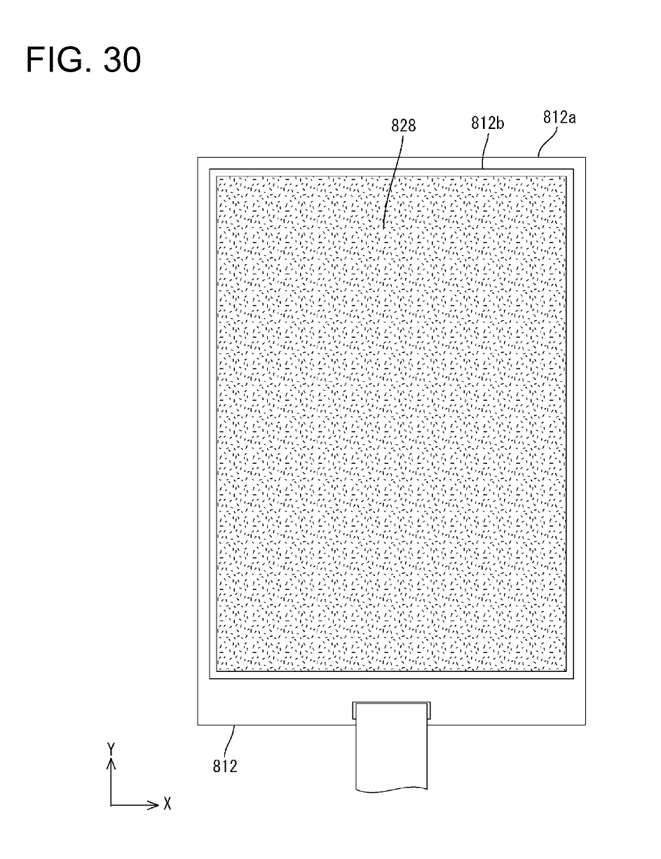

Embodiment 9 of the present invention will be described with reference to FIGS. 30 to 34. In Embodiment 9, a manufacturing method in which the partial curing step is performed before the attaching step will be described. Descriptions of structures, operations, and effects similar to those of Embodiment 1 will be omitted.

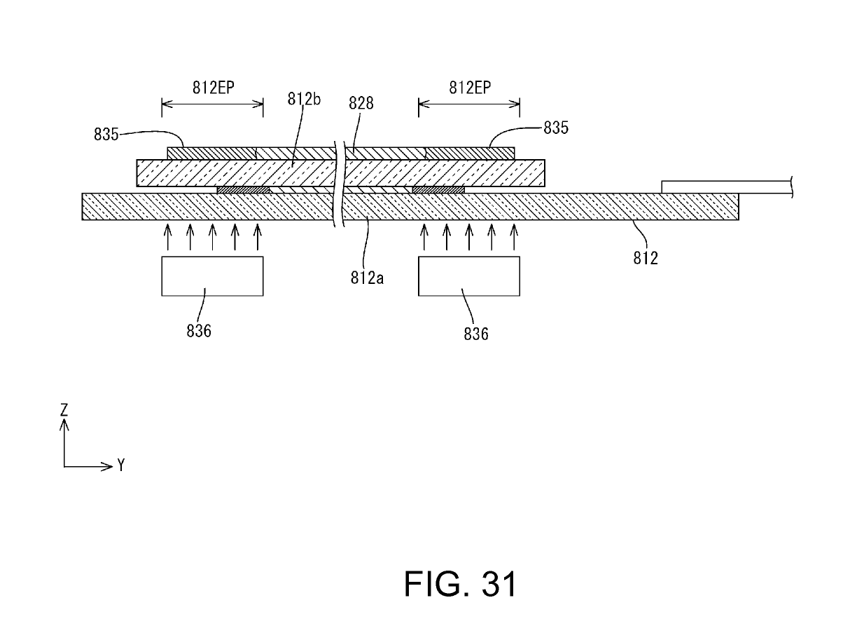

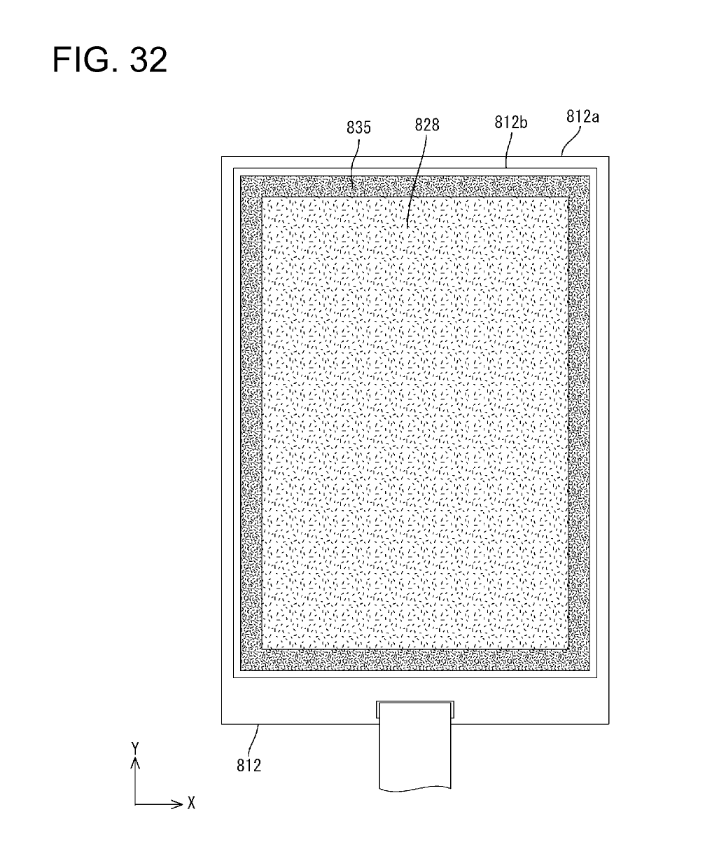

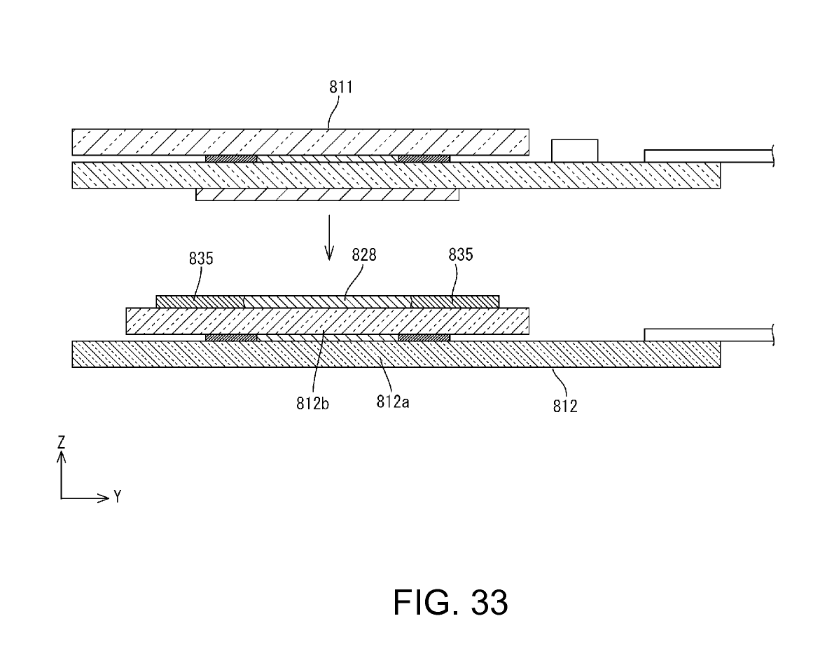

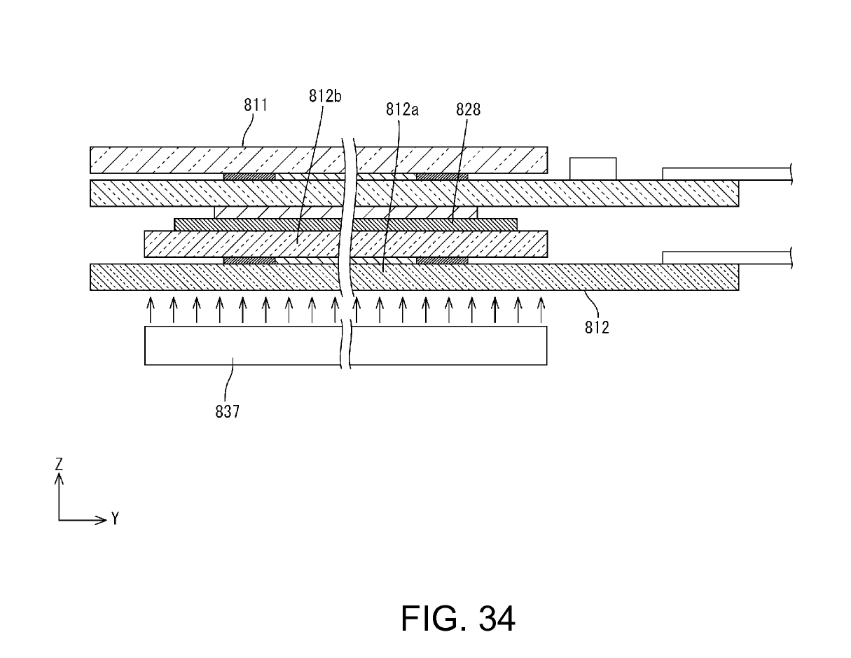

In the present embodiment, as shown in FIG. 30, in the step of coating the adhesive material, an adhesive material 828 is coated in a plane on a second substrate 812b of the parallax barrier panel 812. In FIG. 30, the adhesive material 828 is coated in a halftone screening form. At this time, the adhesive material 828 is coated in a plane on the majority of the central portion but not in the outer edge portion of the second substrate 812b. Next, partial curing is performed on the parallax barrier panel 812 coated with the planar adhesive material 828. As shown in FIG. 31, in the partial curing step, ultraviolet rays are radiated from the partial illumination device 836 disposed opposite to the outer edge portion 812EP of the second substrate 812b of the parallax barrier panel 812, and ultraviolet rays are radiated on the overlapping portion 835 of the adhesive material 828 through both substrates 812a and 812b of the parallax barrier panel 812. As a result, as shown in FIG. 32, the frame-shaped overlapping portion 835 on the outer edge of the adhesive material 828 is partially cured. Then, attaching is performed, and as shown in FIG. 33, the liquid crystal display panel 811 is attached to the front of the parallax barrier panel 812 through the adhesive material 828. Even if the non-cured central portion of the adhesive material 828 spreads during the attaching step, the frame-shaped outer edge portion of the overlapping portion 835 has already been cured, and thus, leakage of the non-cured portion can be prevented. After attaching the two panels 811 and 812 and then adjusting the position thereof, as shown in FIG. 34, the total curing step is performed, thereby curing the entire adhesive material 828 by the total illumination device 837, thus allowing the two panels 811 and 812 to be fixed together by being attached to each other.

### OTHER EMBODIMENTS

The present invention is not limited to the embodiments shown in the drawings and described above, and the following embodiments are also included in the technical scope of the present invention, for example.

(1) In the respective embodiments, in the partial curing step, the ultraviolet rays were radiated by the partial illumination device prior to the adhesive material reaching areas overlapping the outer edge portion, but radiation of the ultraviolet rays by the partial illumination device can be done after the adhesive material reaches a position overlapping the outer edge portion.

(2) Besides what was described in the respective embodiments, the specific degree to which the overlapping portion of the adhesive material is cured can be appropriately modified in the partial curing step.

(3) In Embodiments 1 to 8, in the partial curing step, a case was described in which the degree to which the overlapping portion of the adhesive material is cured is varied in a stepwise fashion between the inner edge portion and the outer edge portion, but the degree of curing of the overlapping portion can be varied in a stepwise fashion between the inner edge portion, the outer edge portion, and an intermediate portion therebetween. Four or more degrees of curing of the overlapping portion naturally can be used.

(4) In a manner opposite to that of (3), the degree of curing of the overlapping portion of the adhesive material in the partial curing step can be made substantially even in Embodiments 1 to 8.

(5) In Embodiment 1, a case was described in which ultraviolet rays are emitted from the partial illumination device to the overlapping portion of the adhesive material through the parallax barrier panel during the partial curing step, but it is also possible to have a configuration in which the partial illumination device is placed to the front of the liquid crystal display panel, and radiates ultraviolet rays to the overlapping portion through the liquid crystal display panel. This method can similarly be applied to Embodiments 7 and 8.

(6) In Embodiment 2, a case was described in which ultraviolet rays are emitted from the partial illumination device to the overlapping portion of the adhesive material through the liquid crystal display panel during the partial curing step, but it is possible to have a configuration in which the partial illumination device is placed to the front of the touch panel, and radiates ultraviolet rays to the overlapping portion of the adhesive material through the touch panel. This method can similarly be applied to Embodiments 3 and 4.

(7) It is possible to apply the configuration of Embodiment 5 to the configurations of Embodiments 2 and 4 to stack a protective panel onto the touch panel or onto the parallax barrier panel having touch panel functionality. In such a case, the protective panel is attached through an adhesive material to the touch panel or the parallax barrier panel having touch panel functionality.

(8) In the respective embodiments, a case was described in which ultraviolet rays are radiated onto the attached panels only from one side during the partial curing step and the total curing step, but ultraviolet rays may be radiated from both front and rear of the attached panels. In such a case, it is preferable that both the liquid crystal display panel and the function panel (such as the parallax barrier panel) have a step structure (where a projection is provided on one of the pair of substrates) in order to attain stepwise curing of the overlapping portion.

(9) In Embodiments 1 to 8, a case was described in which the adhesive material was coated in stripes to extend in the longer side direction of the parallax barrier panel (liquid crystal display panel) in the adhesive material coating step, but the adhesive material can be coated in stripes to extend in the shorter side direction of the parallax barrier panel (liquid crystal display panel) or be coated in stripes to extend in a direction diagonal to both the longer side direction and the shorter side direction, for example. Also, the adhesive material can be coated in a discontinuous fashion as multiple points, and other specific coating methods for the adhesive material can be modified as appropriate.

(10) In the respective embodiments, a case was described in which the adhesive material was coated on the opposing surface of one of the liquid crystal display panel and the function panel (parallax barrier panel) during the adhesive material coating step, but it is possible to coat the adhesive material on the opposing surfaces of both the liquid crystal display panel and the function panel.

(11) In the respective embodiments, a case was described in which ultraviolet rays are radiated in a planar form on the adhesive material by the total illumination device during the total curing step, but it is possible to have a configuration in which the total illumination device radiates ultraviolet rays in a linear fashion on the adhesive material with the attached panels moving relative to the total illumination device, for example, to radiate ultraviolet rays on the entire adhesive material.

(12) In the respective embodiments, a case was described in which the liquid crystal display panel and the function panel (such as the parallax barrier panel) are substantially the same size in a plan view, but the size relation therebetween can be modified as appropriate such that the liquid crystal display panel is larger or the function panel is larger.

(13) In the respective embodiments, a case was described in which an ultraviolet curable adhesive material, which is a type of photocurable adhesive material cured by ultraviolet rays, is used as the adhesive material, but it is possible to use a visible light curable adhesive material cured by visible light, for example. Besides these, a type of photocurable adhesive material cured by both ultraviolet rays and visible light can be used.

(14) In the respective embodiments, a case was described in which an ultraviolet curable adhesive material, which is a type of photocurable adhesive material cured by ultraviolet rays, is used as the adhesive material, but it is also possible to use an ultraviolet/anaerobic curable adhesive material in which curing occurs in an anaerobic setting in addition to ultraviolet rays. Depending on the structure of the panels, there can be locations on the overlapping portion of the adhesive material to which it is difficult to radiate ultraviolet rays, for example, but in such a case, such locations to which it is difficult to radiate ultraviolet rays can be put in an anaerobic setting such as a vacuum to induce curing.

(15) Besides what was described in (14), it is also possible to use as the adhesive an anaerobic curable adhesive in which curing is not induced by light such as ultraviolet rays but is induced by an anaerobic setting.

(16) In the respective embodiments, a case was described in which an ultraviolet curable adhesive material, which is a photocurable adhesive material, is used as the adhesive material, but besides photocurable adhesive materials, a thermosetting adhesive material cured by heat or an electric curable adhesive material cured by the flow of electricity can be used, for example.

(17) Besides what was described in the respective embodiments, the specific materials used for the substrates of the liquid crystal display panel and the function panel (such as the parallax barrier panel) can be modified as appropriate.

(18) In Embodiment 2, the touch panel pattern on the touch panel was of the projected capacitive type, but besides this, the present invention can be applied to a surface capacitive type, a resistive film type, or an electromagnetic induction type touch panel pattern, or the like.

(19) In the respective embodiments, a case was described in which a liquid crystal panel that can function to display a three dimensional image to a user was used, but the present invention can be applied to a liquid crystal panel that can attain so-called multi-view functionality in which users located at two or more different viewing angles see different images, for example.

(20) In the respective embodiments, a case was described in which a switching liquid crystal panel that can switch between two dimensional display and three dimensional display is used, but the liquid crystal panel may have a barrier portion that is always present such that three dimensional images are always displayed, for example.

(21) Besides what was described in (20), it is possible to have a configuration in which a mask filter having a prescribed light-shielding pattern is formed on either of the substrates constituting the liquid crystal panel to always display three dimensional images such that switching to two dimensional display is not possible.

(22) In the respective embodiments, a case was described in which an edge-lit backlight device is used in the liquid crystal display device, but a configuration having a direct-lit backlight device is also included in the present invention.

(23) In the respective embodiments, an example was described of a transmissive liquid crystal display device having a backlight device, which is an external light source, but the present invention can also be applied to a reflective liquid crystal display device performing display using external light, and in such a case, no backlight device is needed.

(24) In the respective embodiments, a liquid crystal display device having a rectangular display surface was described as an example, but a liquid crystal display device having a square display surface is also included in the present invention.

(25) In the respective embodiments, TFTs were used as the switching elements in the liquid crystal display panel included in the liquid crystal display device, but it is possible to use a liquid crystal display device including a liquid crystal display panel having switching elements other than TFTs (such as thin film diodes (TFDs)), and besides liquid crystal display devices including liquid crystal display panels that perform color display, liquid crystal display devices including black and white liquid crystal display panels can also be used.

(26) In the respective embodiments above, a liquid crystal display device using a liquid crystal display panel as a display panel was described as an example, but the present invention can be applied to a display device that uses another type of display panel (such as a PDP or organic EL panel). In such a case, a backlight device can be omitted.

(27) In the respective embodiments, a manufacturing method was described in which, after the liquid crystal display panel and the function panel are attached together, a polarizing plate is attached to the outermost surface of the liquid crystal display panel or the function panel, but besides this, the polarizing plate may be attached to the outermost surface of the liquid crystal display panel or the function panel prior to the liquid crystal display panel and the function panel being attached to each other, for example. In such a case, it is suitable for a laminate film (protective film) to be attached to the outer surface of the polarizing plate attached to the above-mentioned outermost surface such that the polarizing plate is not susceptible to scratches and the like during the attaching step.

### DESCRIPTION OF REFERENCE CHARACTERS

10, 110, 210, 310 liquid crystal display device (display device)
11, 111, 211, 311, 411, 511, 711, 811 liquid crystal display panel (display panel)
12, 312, 412, 512, 612, 712, 812 parallax barrier panel (function panel)
12a, 512a, 712a, 812a first substrate (one substrate)
12b, 312b, 512b, 712b, 812b second substrate (another substrate)
12CP, 612CP central portion
12EP, 612EP, 712EP, 812EP outer edge portion
28, 128, 228, 328, 428, 528, 628, 728, 828 adhesive material
34 projection
35, 135, 635, 735, 835 overlapping portion
35a, 135a, 735a inner edge portion
35b, 135b, 735b outer edge portion
38 touch panel (function panel)
42, 442 protective panel (function panel)
111a CF substrate (another substrate)
111b array substrate (one substrate)
111EP outer edge portion
AA display region
NAA non-display region

1. A method of manufacturing a display device, comprising:
coating a liquid adhesive material on at least either of a display panel that displays images and a function panel to be stacked on the display panel;
attaching the display panel to the function panel through the adhesive material; and
partially curing only a peripheral portion of the adhesive material at a periphery of the combined display and function panels so as to allow minute adjustment of positioning of the display panel and the function panel with respect to each other.

2. The method of manufacturing a display device according to claim 1, wherein, in the step of partially curing the peripheral portion of the adhesive material, a degree of curing of an outer edge portion of the peripheral portion located towards an outside is relatively high, and the degree of curing of an inner edge portion of said peripheral portion located towards an inside is relatively low.

3. The method of manufacturing the display device according to claim 1,
wherein in the step of coating the adhesive material, a photocurable adhesive material is coated as the adhesive material, and
wherein, in the step of partially curing the peripheral portion of the adhesive material, light to induce curing is radiated on the peripheral portion of the photocurable adhesive material.

4. The method of manufacturing a display device according to claim 3,
wherein in the step of coating the adhesive material, an ultraviolet curable adhesive material is coated as the photocurable adhesive material, and
wherein, in the step of partially curing the peripheral portion of the adhesive material, ultraviolet rays to induce curing are radiated on the peripheral portion of the ultraviolet curable adhesive material.

5. The method of manufacturing a display device according to claim 4, wherein, in the step of partially curing the peripheral portion of the adhesive material, the ultraviolet rays are radiated on said peripheral portion through the function panel.

6. The method of manufacturing a display device according to claim 3, further comprising:
manufacturing at least one of the display panel and the function panel, made by attaching together a pair of light-transmissive substrates, such that one of said pair of substrates has a projection that projects further outward than another of said pair of substrates along an entire periphery thereof,
wherein, in the step of partially curing the peripheral portion of the adhesive material, the outer edge portion of said peripheral portion towards the outside is irradiated with the light through the projection of said one of the pair of substrates, whereas the inner edge portion of said peripheral portion located towards the inside is irradiated with light through the pair of substrates.

7. The method of manufacturing a display device according to claim 6, wherein, in the step of attaching, the display panel is attached to the function panel such that said another of the pair of substrates faces the adhesive material.

8. The method of manufacturing a display device according to claim 1, wherein the step of partially curing the peripheral portion of the adhesive material is performed simultaneously to the step of attaching.

9. The method of manufacturing a display device according to claim 8,
wherein, in the step of attaching, the adhesive material is spread under pressure by applying pressure to at least one of the display panel and the function panel.

10. The method of manufacturing a display device according to claim 9,
wherein, in the step of coating the adhesive material, the adhesive material is coated onto a central portion surrounded by an outer edge portion of at least one of the display panel and the function panel, and
wherein, in the step of partially curing the peripheral portion of the adhesive material, curing is performed on the adhesive material, spreading in the step of attaching, prior to the adhesive material reaching the outer edge portion of the display panel and the function panel.

11. The method of manufacturing a display device according to claim 8, wherein, in the step of partially curing the peripheral portion of the adhesive material, the peripheral portion is half-cured.

12. The method of manufacturing a display device according to claim 11, further comprising:
adjusting a position of the display panel relative to the function panel in a horizontal direction, after the step of attaching and the step of partially curing the peripheral portion of the adhesive material.

13. The method of manufacturing a display device according to claim 12, wherein, in the step of attaching, a parallax barrier panel that can split by parallax an image displayed in the display panel is attached to the display panel as the function panel.

14. The method of manufacturing a display device according to claim 12, wherein, in the step of attaching, a touch panel that can detect an input position by a user of said display device is attached to the display panel as the function panel.

15. The method of manufacturing a display device according to claim 1, wherein, in the step of partially curing the peripheral portion of the adhesive material, curing is performed on the peripheral portion of the adhesive material that overlaps in a plan view a non-display region surrounding a display region where images are displayed in the display panel.

16. The method of manufacturing a display device according to claim 12, further comprising:
fully curing an entirety of the adhesive material after the step of adjusting.
